(19) United States
(12) Patent Application Publication
(10) Pub. No.: US 2004/0053996 A1
(43) Pub. Date: Mar. 18, 2004

(54) Use of oxabicyclo[2.2.1]heptane derivatives as pesticidal agents

(76) Inventors: Ernst Rudolf F. Gesing, Erkrath-Hochdahl (DE); Christoph Erdelen, Leichlingen (DE); Gerd Hanssler, Leverkusen (DE); Karl-Heinz Kuck, Langenfeld (DE); Peter Losel, Leverkusen (DE); Wolfram Andersch, Bergisch (DE); Yi-Mei Xu, Shanghai (CN); Liang Chen, Shanghai (CN); Qinghong Tang, Shanghai (CN); Jin Cao, Shanghai (CN)

Correspondence Address: BAYER CHEMICALS CORPORATION, PATENT DEPARTMENT, 100 BAYER ROAD, PITTSBURGH, PA, 15205-9741, US

(21) Appl. No.: 10/432,071

(22) PCT Filed: Nov. 15, 2002
(86) PCT No.: PCT/EP01/13212

(30) Foreign Application Priority Data
Nov. 23, 2000 (CN) 00 1 28459.2

(51) Int. Cl. A01N 43/08

(52) U.S. Cl. 514/469

(57) ABSTRACT

7-oxabicyclo[2.2.1]heptane derivatives of formula (I) in which X, R¹, R², R³ and R⁴ have the meanings set forth in the specification, are very suitable for controlling undesired microorganisms and animal pests. New 7-oxabicyclo[2.2.1]heptane derivatives of formula (Ia) in which X, R¹, R², R³ and R¹⁴ have the meanings set forth in the specification, and a process for the preparation of the new compounds.

The present invention relates to the new use of certain 7-oxabicyclo[2.2.1]heptane derivatives for controlling undesired microorganisms and animal pests.

Various 7-oxabicyclo[2.2.1]heptane derivatives are already known from the art. Thus, 7-oxabicyclo[2.2.1]heptane-2,3-dicarboxylic acid bis(phenylmethyl)ester, 7-oxabicyclo[2.2.1]hept-5-ene-2,3-dicarboxylic acid bis-(phenylmethyl)-ester and 7-oxabicyclo[2.2.1]hept-2-ene-5,6-dicarboxylic acid bis-methyl-ester have been described as chemical compounds (cf. J. Mol. Catal. 90, 143-156 (1994), ACS Symp. Ser. 620, 364-380 (1996) and J. Chem. Educ. 76 659-660 (1999).

A microbicidal or other pesticidal activity of such compounds, however, has not been disclosed until now.

It has now been found that 7-oxabicyclo[2.2.1]heptane derivatives of the formula

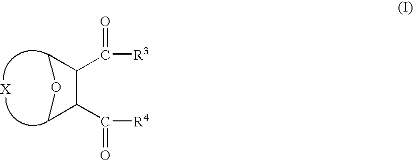

in which

X represents a group of the formula —CH₂—CH₂— or —CH═CH—,

R¹ and R², independently of one another, represent hydrogen or methyl,

R³ represents a group selected from —OR⁵, —SR⁶ and —NH—R⁷, wherein

R⁵, R⁶ and R⁷, independently of one another, represent hydrogen, alkyl, halogenoalkyl, alkoxyalkyl, halogenoalkoxy-alkyl, alkinyl, optionally substituted cycloalkyl, optionally substituted aryl, optionally substituted aralkyl, optionally substituted aryloxyalkyl, optionally substituted. arylalkinyl, optionally substituted heterocyclyl or optionally substituted heterocyclylalkyl, and

R⁴ represents a group selected from —OR⁸, —SR⁹ and —NH—R¹⁰,

wherein

R⁸, R⁹ and R¹⁰, independently of one another, represent hydrogen, alkyl, halogenoalkyl, alkoxyalkl, halogenoalkoxy-alkyl, alkinyl, optionally substituted cycloalkyl, optionally substituted aryl, optionally substituted aralkyl, optionally substituted aryloxyalkyl, optionally substituted arylalkinyl, optionally substituted heterocyclyl or optionally substituted heterocyclylalkyl, or

R³ and R⁴ together represent a group of the formula

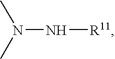

wherein

R¹¹ represents optionally substituted aryl, or

R³ and R⁴ together represent a group of the formula

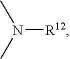

wherein

R¹² represents optionally substituted aralkyl, are very suitable for controlling undesired microorganisms and animal pests.

Surprisingly, the compounds according to the invention show a markedly better activity against undesired microorganisms and animal pests than the constitutionally most similar compounds which are known from the prior art.

Depending on the nature of the substituents, the 7-oxabicyclo[2.2.1]heptane derivatives of the formula (I) can be present as geometrical and/or optical isomers or as mixtures of such isomers. The invention relates to both, the pure isomers and mixtures of isomers.

Formula (I) provides a general definition of the 7-oxabicyclo[2.2.1]heptane derivatives which can be used according to the invention.

X preferably represents a group of the formula —CH₂—CH₂— or —CH═CH.

R¹ preferably represents hydrogen or methyl.

R² preferably represents hydrogen or methyl.

R³ preferably represents a group selected from —OR⁵, —SR⁶ and —NH—R⁷,

wherein

R⁵ preferably represents hydrogen, straiglht-chain or branched alkyl having 1 to 8 carbon atoms, halogenoalkyl having 1 to 8 carbon atoms and 1 to 6 halogen atoms, alkoxyalkyl having 1 to 6 carbon atoms in the alkyl group and 1 to 6 carbon atoms in each alkoxy group, halogenoalkoxyalkyl having 1 to 6 carbon atoms in the alkyl group and 1 to 6 carbon atoms as well as 1 to 6 halogen atoms in each halogenoalkoxy group, alkinyl having 3 to 8 carbon atoms, or

R⁵ preferably represents cycloalkyl having 3 to 7 carbon atoms, wherein each of these groups may be mono- to tri-substituted by identical or different radicals selected from alkyl having 1 to 4 carbon atoms and alkoxy having 1 to 4 carbon atoms, or wherein the cycloalkyl group may contain a fused phenyl ring, which in turn may be substituted by on to three identical of different radicals selected from alkyl having 1 to 4 carbon atoms and alkoxy having 1 to 4 carbon atoms, or

R⁵ preferably represents aryl having 6 to 10 carbon atoms, wherein each of these groups may be mono- to tri-substituted by identical or different radicals selected from the group consisting of halogen, nitro, cyano, aminocarbonylamino, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenoxy, halophenoxy, carbalkoxy having 1 to 6 carbon atoms in the alkoxy group, and piperazinyl, which in turn may be substituted by alkyl having 1 to 4 carbon atoms, or

R⁵ preferably represents arylalkyl having 6 to 10 carbon atoms in the aryl group and 1 to 6 carbon atoms in the alkyl group, wherein each of these groups may be mono- to tri-substituted by identical of different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenylalkoxy having 1 to 4 carbon atoms in the alkoxy group, alkylthio having 1 to 6 carbon atoms and phenoxy, which in turn may be substituted by halogen, alkyl having 1 to 4 carbon atoms, alkylthio having 1 to 4 carbon atoms and/or dialkylamino having 1 to 4 carbon atoms in each alkyl group, or

R⁵ preferably represents aryloxyalkyl having 6 to 10 carbon atoms in the aryloxy group and 1 to 4 carbon atoms in the alkyl group, wherein the aryloxy group may be substituted by 1 to 3 identical or different radicals selected from halogen and alkyl having 1 to 4 carbon atoms, or

R⁵ preferably represents arylalkinyl having 6 to 10 carbon atoms in the aryl group and 3 to 6 carbon atoms in the alkinyl group, wherein the aryl group may be substituted by 1 to 3 identical or different radicals selected from halogen and alkyl having 1 to 4 carbon atoms, or

R⁵ preferably represents 5 or 6-membered heterocyclyl having 1 to 3 heteroatoms, such as nitrogen, sulphur and/or oxygen, wherein the heterocyclic groups may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogeno-alkoxy having 1 to 6 carbon atoms and 1 to 5 identical or different halogen atoms, cycloalkyl having 3 to 8 carbon atoms, phenyl and phenoxy, which in turn may be substituted by 1 to 3 halogen atoms, or

R⁵ preferably represents 5- or 6-membered heterocyclylallyl having 1 to 6 carbon atoms in the alkyl group and 1 to 3 heteroatoms, such as nitrogen, sulphur and/or oxygen, in the heterocyclyl group, wherein the heterocyclyl groups may be benzo-annellated and may be mono- to tri-substituted by identical or different radicals selected from the group consisting of halogen, nitro, alkoxycabonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy,

R⁶ preferably represents hydrogen, straight-chain or branched alkyl having 1 to 8 carbon atoms, halogenoalkyl having 1 to 8 carbon atoms and 1 to 6 halogen atoms, alkoxyalkyl having 1 to 6 carbon atoms in the alyl group and 1 to 6 carbon atoms in each alkoxy group, halogenoalkoxyalyl having 1 to 6 carbon atoms in the alkyl group and 1 to 6 carbon atoms as well as 1 to 6 halogen atoms in each halogenalkoxy group, alkinyl having 3 to 8 carbon atoms, or

R⁶ preferably represents cycloalkyl having 3 to 7 carbon atoms, wherein each of these groups may be mono- to tri-substituted by identical or different radicals selected from alkyl having 1 to 4 carbon atoms and alkoxy having 1 to 4 carbon atoms, or wherein the cycloalkyl group may contain a fused phenyl ring, which in turn may be substituted by one to three identical or different radicals selected from alkyl having 1 to 4 carbon atoms and alkoxy having 1 to 4 carbon atoms, or

R⁶ preferably represents aryl having 6 to 10 carbon atoms, wherein each of these groups may be mono- to tri-substituted by identical or different radicals selected from the group consisting of halogen, nitro, cyano, aminocarbonylamino, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenoxy, halophenoxy, carbalkoxy having 1 to 6 carbon atoms in the alkoxy group, and piperazinyl, which in turn may be substituted by alkyl having 1 to 4 carbon atoms, or

R⁶ preferably represents arylalkyl having 6 to 10 carbon atoms in the aryl group and 1 to 6 carbon atoms in the alkyl group, wherein each of these groups may be mono- to tri-substituted by identical or different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenylalkoxy having 1 to 4 carbon atoms in the alkoxy group, alkylthio having 1 to 6 carbon atoms and phenoxy, which in turn may be substituted by halogen, alkyl having 1 to 4 carbon atoms, alkylthio having 1 to 4 carbon atoms and/or dialkyl-amino having 1 to 4 carbon atoms in each alkyl group, or

R⁶ preferably represents aryloxyalkyl having 6 to 10 carbon atoms in the aryloxy group and 1 to 4 carbon atoms in the alkyl group, wherein the aryloxy group may be substituted by 1 to 3 identical or different radicals selected from halogen and alkyl having 1 to 4 carbon atoms or

R⁶ preferably represents arylalkinyl having 6 to 10 carbon atoms in the aryl group and 3 to 6 carbon atoms in the alkinyl group, wherein the aryl group may be substituted by 1 to 3 identical or different radicals selected from halogen and alkyl having 1 to 4 carbon atoms, or

R⁶ preferably represents 5- or 6-membered heterocyclyl having 1 to 3 heteroatoms, such as nitrogen, sulphur and/or oxygen, wherein the heterocyclic group may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy, which in turn may be substituted by 1 to 3 halogen atoms, or

R⁶ preferably represents 5- or 6-membered heterocyclylalkyl having 1 to 6 carbon atoms in the allyl group and 1 to 3 heteroatoms, such as nitrogen, sulphur and/or oxygen, in the heterocyclyl group, wherein the heterocyclyl groups may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogeno alkoxy having 1 to 6 carbon atoms and 1 to 5 identical or different halogen atoms, cycloalkyl having 3 to 8 carbon atoms, phenyl and phenoxy, and

R⁷ preferably represents hydrogen, straight-chain or branched alkyl having 1 to 8 carbon atoms, halogenoalkyl having 1 to 8 carbon atoms and 1 to 6 halogen atoms, alkoxyalkyl having 1 to 6 carbon atoms in the alkyl group and 1 to 6 carbon atoms in each alkoxy group, halogenoalkoxyalkyl having 1 to 6 carbon atoms in the alkyl group and 1 to 6 carbon atoms as well as 1 to 6 halogen atoms in each halogenoalkoxy group, alkinyl having 3 to 8 carbon atoms, or

R⁷ preferably represents cycloalkyl having 3 to 7 carbon atoms, wherein each of these groups may be mono- to tri-substituted by identical or different radicals selected from alkyl having 1 to 4 carbon atoms and alkoxy having 1 to 4 carbon atoms, or wherein the cycloalkyl group may contain a fused phenyl ring, which in turn may be substituted by one to three identical of different radicals selected from alkyl having 1 to 4 carbon atoms and alkoxy having 1 to 4 carbon atoms, or

R⁷ preferably represents aryl having 6 to 10 carbon atoms, wherein each of these groups may be mono- to tri-substituted by identical or different radicals selected from the group consisting of halogen, nitro, cyano, aminocarbonylamino, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenoxy, halophenoxy, carbalkoxy having 1 to 6 carbon atoms in the alkoxy group, and piperazinyl, which in turn may be substituted by alkyl having 1 to 4 carbon atoms, or

R⁷ preferably represents arylalkyl having 6 to 10 carbon atoms in the aryl group and 1 to 6 carbon atoms in the alkyl group, wherein each of these groups may be mono- to tri-substituted by identical or different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenylalkoxy having 1 to 4 carbon atoms in the alkoxy group, alkylthio having 1 to 6 carbon atoms and phenoxy, which in turn may be substituted by halogen, alkyl having 1 to 4 carbon atoms, alkylthio having 1 to 4 carbon atoms and/or dialkylamino having 1 to 4 carbon atoms in each alkyl group, or

R⁷ preferably represents aryloxyalkyl having 6 to 10 carbon atoms in the aryloxy group and 1 to 4 carbon atoms in the alkyl group, wherein the aryloxy group may be substituted by 1 to 3 identical or different radicals selected from halogen and alkyl having 1 to 4 carbon atoms or

R⁷ preferably represents arylalkinyl having 6 to 10 carbon atom in the aryl group and 3 to 6 carbon atoms in the alkinyl group, wherein the aryl group may be substituted by 1 to 3 identical or different radicals selected from halogen and alkyl having 1 to 4 carbon atoms,

R⁷ preferably represents 5- or 6-membered heterocyclyl having 1 to 3 heteroatoms, such as nitrogen, sulphur and/or oxygen, wherein the heterocyclic group may be benzo-annellated and may be mono-to tri-substituted by identical of different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy, which in turn may be substituted by 1 to 3 halogen atoms, or

R⁷ preferably represents 5- or 6-membered heterocyclylalkyl having 1 to 6 carbon atoms in the alkyl group and 1 to 3 heteroatoms, such as nitrogen, sulphur and/or oxygen, in the heterocyclyl group wherein the heterocyclyl groups may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy,

R⁴ preferably represents a group selected from —OR⁸, —SR⁹— and —NH—R¹⁰, wherein

R⁸ preferably represents hydrogen, straight-chain or branched alkyl having 1 to 8 carbon atoms, halogenoalkyl having 1 to 8 carbon atoms and 1 to 6 halogen atoms, alkoxyalkyl having 1 to 6 carbon atoms in the alkyl group and 1 to 6 carbon atoms in each alkoxy group, halogenoalkoxyalkyl having 1 to 6 carbon atoms in the alkyl group and 1 to 6 carbon atoms as well as 1 to 6 halogen atoms in each halogenoalkoxy group, alkinyl having 3 to 8 carbon atoms, or

R⁸ preferably represents cycloalkyl having 3 to 7 carbon atoms, wherein each of these groups may be mono- to tri-substituted by identical or different radicals selected from alkyl having 1 to 4 carbon atoms and alkoxy having 1 to 4 carbon atoms, or wherein the cycloalkyl group may contain a fused phenyl ring, which in turn may be substituted by one to three identical or different radicals selected from alkyl having 1 to 4 carbon atoms and alkoxy having 1 to 4 carbon atoms, or

R⁸ preferably represents aryl having 6 to 10 carbon atoms, wherein each of these groups may be mono- to tri-substituted by identical or different radicals selected from the group consisting of halogen, nitro, cyano, aminocarbonylamino, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenoxy, halophenoxy, carbalkoxy having 1 to 6 carbon atoms in the alkoxy group, and piperazinyl, which in turn may be substituted by alkyl having 1 to 4 carbon atoms, or

R⁸ preferably represents arylalkyl having 6 to 10 carbon atoms in the aryl group and 1 to 6 carbon atoms in the alkyl group, wherein each of these groups may be groups may be mono- to tri-substituted by identical or different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenylalkoxy having 1 to 4 carbon atoms in the alkoxy group, alkylthio having 1 to 6 carbon atoms and phenoxy, which in turn may be substituted by halogen, alkyl having 1 to 4 carbon atoms, alkylthio having 1 to 4 carbon atoms and/or dialkylamino having 1 to 4 carbon atoms in each alkyl group, or

R⁸ preferably represents aryloxyalkyl having 6 to 10 carbon atoms in the aryloxy group and 1 to 4 carbon atoms in the alkyl group, wherein the aryloxy group may be substituted by 1 to 3 identical or different radicals selected from halogen and alkyl having 1 to 4 carbon atoms, or

R⁸ preferably represents arylalkinyl having 6 to 10 carbon atoms in the aryl group and 3 to 6 carbon atoms in the alkinyl group, wherein the aryl group may be substituted by 1 to 3 identical or different radicals selected from halogen and alkyl having 1 to 4 carbon atoms, or

R⁸ preferably represents 5- or 6-membered heterocyclyl having 1 to 3 heteroatoms, such as nitrogen, sulphur and/or oxygen, wherein the heterocyclic group may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy, which in turn may be substituted by 1 to 3 halogen atoms, or

R⁸ preferably represents 5- or 6-membered heterocyclylalkyl having 1 to 6 carbon atoms in the alkyl group and 1 to 3 heteroatoms, such as nitrogen, sulphur and/or oxygen, in the heterocyclyl group wherein the heterocyclyl groups may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy,

R⁹ preferably represents hydrogen, straight-chain or branched alkyl having 1 to 8 carbon atoms, halogenoalkyl having 1 to 8 carbon atoms and 1 to 6 halogen atoms, alkoxyalkyl having 1 to 6 carbon atoms in the alkyl group and 1 to 6 carbon atoms in each alkoxy group, halogenoalkoxyalkyl having 1 to 6 carbon atoms in the alkyl group and 1 to 6 carbon atoms as well as 1 to 6 halogen atoms in each halogenoalkyl group, alkinyl having 3 to 8 carbon atoms, or

R⁹ preferably represents cycloalkyl having 3 to 7 carbon atoms, wherein each of these groups may be mono- to tri-substituted by identical or different radicals selected from alkyl having 1 to 4 carbon atoms and alkoxy having 1 to 4 carbon atoms, or wherein the cycloalkyl group may contain a fused phenyl ring, which in turn may be substituted by one to three identical or different radicals selected from alkyl having 1 to 4 carbon atoms and alkoxy having 1 to 4 carbon atoms, or

R⁹ preferably represents aryl having 6 to 10 carbon atoms, wherein each of these groups may be mono- to tri-substituted by identical or different radicals selected from the group consisting of halogen, nitro, cyano, aminocarbonylamino, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenoxy, halophenoxy, carbalkoxy having 1 to 6 carbon atoms in the alkoxy group, and piperazinyl, which in turn may be substituted by alkyl having 1 to 4 carbon atoms, or

R⁹ preferably represents arylalkyl having 6 to 10 carbon atoms in the aryl group and 1 to 6 carbon atoms in the allyl group, wherein each of these groups may be mono- to tri-substituted by identical or different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenylalkoxy having 1 to 4 carbon atoms in the alkoxy group, alkylthio having 1 to 6 carbon atoms and phenoxy, which in turn may be substituted by halogen, alkyl having 1 to 4 carbon atoms, alkylthio having 1 to 4 carbon atoms and/or dialkylamino having 1 to 4 carbon atoms in each alkyl group, or

R⁹ preferably represents aryloxyalkyl having 6 to 10 carbon atoms in the aryloxy group and 1 to 4 carbon atoms in the alkyl group, wherein the aryloxy group may be substituted by 1 to 3 identical or different radicals selected from halogen and alkyl having 1 to 4 carbon atoms, or

R⁹ preferably represents aryloxyalkyl having 6 to 10 carbon atoms in the aryl group and 3 to 6 carbon atoms in the alkinyl group, wherein the aryl group may be substituted by 1 to 3 identical or different radicals selected from halogen and alkyl having 1 to 4 carbon atoms, or

R⁹ preferably represents 5- or 6-membered heterocyclyl having 1 to 3 heteroatoms, such as nitrogen, sulphur and/or oxygen, wherein the heterocyclic group may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy, which in turn may be substituted by 1 to 3 halogen atoms, or

R⁹ preferably represents 5- or 6-membered heterocyclylalkyl having 1 to 6 carbon atoms in the alkyl group and 1 to 3 heteroatoms, such as nitrogen, sulphur and/or oxygen, in the heterocyclyl group, wherein the heterocyclyl groups may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy, and

R¹⁰ preferably represents hydrogen, straight-chain or branched alkyl having 1 to 8 carbon atoms, halogenoalkyl having 1 to 8 carbon atoms and 1 to 6 halogen atoms, alkoxyalkyl having 1 to 6 carbon atoms in the alkyl group and 1 to 6 carbon atoms in each alkoxy group, halogenoalkoxyalkyl having 1 to 6 carbon atoms in the alkyl group and 1 to 6 carbon atoms as well as 1 to 6 halogen atoms in each halogenoalkyl group, alkinyl having 3 to 8 carbon atoms, or

R¹⁰ preferably represents cycloalkyl having 3 to 7 carbon atoms, wherein each of these groups may be mono- to tri-substituted by identical or different radicals selected from alkyl having 1 to 4 carbon atoms and alkoxy having 1 to 4 carbon atoms, or wherein the cycloalkyl group may contain a fused phenyl ring, which in turn may be substituted by one to three identical or different radicals selected from alkyl having 1 to 4 carbon atoms and alkoxy having 1 to 4 carbon atoms, or

R¹⁰ preferably represents aryl having 6 to 10 carbon atoms, wherein each of these groups may be mono- to tri-substituted by identical or different radicals selected from the group consisting of halogen, nitro, cyano, aminocarbonylamino, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenoxy, halophenoxy, carbalkoxy having 1 to 6 carbon atoms in the alkoxy group, and piperazinyl, which in turn may be substituted by alkyl having 1 to 4 carbon atoms, or

R¹⁰ preferably represents arylalkyl having 6 to 10 carbon atoms in the aryl group and 1 to 6 carbon atoms in the alkyl group, wherein each of these groups may be mono- to tri-substituted by identical or different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenylalkoxy having 1 to 4 carbon atoms in the alkoxy group, alkylthio having 1 to 6 carbon atoms and phenoxy, which in turn may be substituted by halogen, alkyl having 1 to 4 carbon atoms, alkylthio having 1 to 4 carbon atoms and/or dialkylamino having 1 to 4 carbon atoms in each alkyl group,

R¹⁰ preferably represents aryloxyalkyl having 6 to 10 carbon atoms in the aryloxy group and 1 to 4 carbon atoms in the alkyl group, wherein the aryloxy group may be substituted by 1 to 3 identical or different radicals selected from halogen and alkiny having 1 to 4 carbon atoms, or

R¹⁰ preferably represents aryloxyalkyl having 6 to 10 carbon atom in the aryl group and 3 to 6 carbon atoms in the alkinyl group, wherein the aryl group may be substituted by 1 to 3 identical or different radicals selected from halogen and alkyl having 1 to 4 carbon atoms, or

R¹⁰ preferably represents 5- or 6-membered heterocyclyl having 1 to 3 heteroatoms, such as nitrogen, sulphur and/or oxygen, wherein the heterocyclic group may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy, which in turn may be substituted by 1 to 3 halogen atoms, or

R¹⁰ preferably represents 5- or 6-membered heterocyclylalkyl having 1 to 6 carbon atoms in the alkyl group and 1 to 3 heteroatoms, such as nitrogen, sulphur and/or oxygen, in the heterocyclyl group wherein the heterocycyl groups may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy,

R³ and R⁴ also together represent a group of the formula

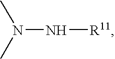

wherein

R¹¹ preferably represents aryl having 6 to 10 carbon atoms, wherein each of these groups may be mono- to tri-substituted by identical or different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy, or

R³ and R⁴ together represent a group of the formula

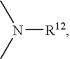

wherein

R¹² preferably represents aralkyl having 6 to 10 carbon atoms in the aryl group and 1 to 4 carbon atoms in the alkyl group, wherein the aryl group may be substituted by 1 to 3 identical or different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy.

Particularly preferred are 7-oxabicyclo[2.2.1]heptane derivatives of the formula (I), in which

X represents a group of the formula —CH₂—CH₂— or —CH═CH—,

R¹ represents hydrogen or methyl,

R² represents hydrogen or methyl,

R³ represents a group selected from —OR⁵, —SR⁶ and —NH—R⁷, wherein

R⁵ represents hydrogen, straight-chain or branched all having 1 to 6 carbon atoms, halogenoalkyl having 1 to 6 carbon atoms and 1 to 5 fluorine, chlorine and/or bromine atoms, alkoxyalkyl having 1 to 4 carbon atoms in the alkyl group and 1 to 4 carbon atoms in each alkoxy group, halogenoalkoxyalkyl having 1 to 4 carbon atoms in the alkoxy group and 1 to 6 carbon atoms and 1 to 5 fluorine and/or chlorine atoms in the halogenoalkoxy group, halogenoalkoxy-alkoxy-alkyl having 1 to 4 carbon atoms in the alkyl group, 1 to 4 carbon atoms in the alkoxy group and 1 to 6 carbon atoms as well as 1 to 5 fluorine and/or chlorine atoms in the halogenoalkoxy group, alkinyl having 3 to 6 carbon atoms, or

R⁵ represents cycloalkyl having 3 to 6 carbon atoms, wherein each of these group may be substituted by 1 to 3 identical or different radicals selected from alkyl having 1 or 2 carbon atoms and alkoxy having 1 or 2 carbon atoms, or wherein the cycloalkyl group may contain a fused phenyl ring, which in turn may be substituted by 1 to 3 identical or different radicals selected from alkyl having 1 or 2 carbon atoms and alkoxy having 1 or 2 carbon atoms, or

R⁵ represents phenyl, which may be mono- to tri-substituted by identical or different radicals selected from the group consisting of fluorine, chlorine, bromine, nitro, cyano, aminocarbonylamino, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl, phenoxy, chlorophenoxy, fluorophenoxy, carbalkoxy having 1 to 4 carbon atoms in the alkoxy group and piperazinyl, which in turn may be substituted by alkyl having 1 or 2 carbon atoms, or

R⁵ represents naphthylalkyl having 1 to 4 carbon atoms in the alkyl or

R⁵ represents phenylalkyl having 1 to 6 carbon atoms in the alkyl group, wherein the phenyl group may be mono to tri-substituted by identical or different radicals selected from the group consisting of fluorine, chlorine, bromine, nitro, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogeno alkoxy having 1 to 4 carbon atoms and 1 to 5 fluorine, chlorine and/or bromine atoms, cycloalkyl having 3 to 7 carbon atoms, phenyl, phenylalkoxy having 1 to 4 carbon atoms in the alkoxy group, alkylthio having 1 to 4 carbon atoms and phenoxy, which in turn may be substituted by 1 to 3 radicals selected from fluorine, chlorine, methyl, ethyl, methylthio, ethylthio and/or dialkylamino having 1 or 2 carbon atoms in each alkyl group, or

R⁵ represents phenyloxyalkyl having 1 to 4 carbon atoms in the oxyalkyl group, wherein the phenyl group may be substituted by 1 to 3 identical or different radicals selected from fluorine chlorine, methyl and ethyl,

R⁵ represents phenylalkinyl having 3 to carbon atoms in the alkinyl group, wherein the phenyl group may be substituted by 1 to 3 identical or different radicals selected from fluorine, chlorine, methyl and ethyl, or

R⁵ represents 5- or 6-membered heterocyclyl having 1 to 3 heteroatoms, such as nitrogen, sulphur and/or oxygen, wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkyl having 1 to 4 carbon atoms and 1 to 5 fluorine, chlorine and/or bromine atoms, cycloalkyl having 3 to 7 carbon atoms, phenyl and phenoxy, which in turn may be substituted by 1 to 3 fluorine and/or chlorine atoms, or

R⁵ represents 5- or 6-membered heterocyclylalkyl having 1 to -4 carbon atoms in the alkyl group and 1 to 3 heteroatoms, such as nitrogen, sulphur and/or oxygen, in the heterocyclyl group, wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy,

R⁶ represents hydrogen, straight-chain or branched alkyl having 1 to 6 carbon atoms, halogenoalkyl having 1 to 6 carbon atoms and 1 to 5 fluorine chlorine and/or bromine atoms, alkoxyalkyl having 1 to 4 carbon atoms in the alkyl group and 1 to 4 carbon atoms in each alkoxy group, halogenoalkoxyalkyl having 1 to 4 carbon atoms in the alkyl group and 1 to 6 carbon atoms and 1 to 5 fluorine and/or chlorine atoms in the halogenoalkyl group, halogenoalkoxy-alkoxy-alkyl having 1 to 4 carbon atoms in the alkyl group, 1 to 4 carbon atoms in the alkoxy group and 1 to 6 carbon atoms as well as 1 to 5 fluorine and/or chlorine atoms in the halogenoalkoxy group, alkinyl having 3 to 6 carbon atoms, or

R⁶ represents cycloalkyl having 3 to 6 carbon atoms, wherein each of these groups may be substituted by 1 to 3 identicals or different radicals selected from alkyl having 1 or 2 carbon atoms and alkoxy having 1 or 2 carbon atoms, or wherein the cycloalkyl group may contain a fused phenyl ring, which in turn may be substituted by 1 to 3 identical or different radicals selected from alkyl having 1 or 2 carbon atoms and alkoxy having 1 or 2 carbon atoms, or

R⁶ represents phenyl, which may be mono- to tri-substituted by identical or different radicals selected from the group consisting of fluorine, chlorine, bromine, nitro, cyano, aminocarbonylamino, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl, phenoxy, chlorophenoxy, fluorophenoxy, carbalkoxy having 1 to 4 carbon atoms in the alkoxy group and piperazinyl, which in turn may be substituted by alkyl having 1 or 2 carbon atoms, or

R⁶ represents naphthylalkyl having 1 to 4 carbon atoms in the alkyl group, or

R⁶ represents phenylalkyl having 1 to 6 carbon atoms in the alkyl group, wherein the phenyl group may be mono- to tri-substituted by identical or different radicals selected from the group consisting of fluorine, chlorine, bromine, nitro, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl, phenylalkoxy having 1 to 4 carbon atoms in the alkoxy group, alkylthio having 1 to 4 carbon atoms and phenoxy, which in turn may be substituted by 1 to 3 radicals selected from fluorine, chlorine, methyl, ethyl, methylthio, ethylthio and/or dialkylamino having 1 or 2 carbon atoms in each alkyl group, or

R⁶ represents phenyloxyalkyl having 1 to 4 carbon atoms in the oxyalkyl group, wherein the phenyl group may be substituted by 1 to 3 identical or different radicals selected from fluorine, chlorine, methyl and ethyl, or

R⁶ represents phenylalkinyl having 3 to 6 carbon atoms in the alkinyl group, wherein the phenyl group may be substituted by 1 to 3 identical or different radicals selected from fluorine, chlorine, methyl and ethyl, or

R⁶ represents 5- or 6-membered heterocyclyl having 1 to 3 heteroatoms, such as nitrogen, sulphur and/or oxygen, wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy, which in turn may be substituted by 1 to 3 fluorine and/or chlorine atoms, or

R⁶ represents 5- or 6-membered heterocyclylalkyl having 1 to 4 carbon atoms in the alkyl group and 1 to 3 heteroatoms, such as nitrogen, sulphur and/or oxygen, in the heterocyclyl group wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy, and

R⁷ represents hydrogen, straight-chain or branched alkyl having 1 to 6 carbon atoms, halogenoalkyl having 1 to 6 carbon atoms and 1 to 5 fluorine, chlorine and/or bromine atoms, alkoxyalkyl having 1 to 4 carbon atoms in the alkyl group and 1 to 4 carbon atoms in each alkoxy group, halogenoalkoxyalkyl having 1 to 4 carbon atoms in the alkyl group and 1 to 6 carbon atoms and 1 to 5 fluorine and/or chlorine atoms in the halogenoalkoxy group, halogenoalkoxy-alkoxy-alkyl having 1 to 4 carbon atoms in the alkyl group, 1 to 4 carbon atoms in the alkoxy group and 1 to 6 carbon atoms as well as 1 to 5 fluorine and/or chlorine atoms in the halogenoalkoxy group, alkinyl having 3 to 6 carbon atoms, or

R⁷ represents cycloalkyl having 3 to 6 carbon atoms, wherein each of these groups may be substituted by 1 to 3 identical or different radicals selected from alkyl having 1 or 2 carbon atoms and alkoxy having 1 or 2 carbon atoms, or wherein the cycloalkyl group may contain a fused phenyl ring, which in turn may be substituted by 1 to 3 identical or different radicals selected from alkyl having 1 or 2 carbon atoms and alkoxy having 1 or 2 carbon atoms, or

R⁷ represents phenyl, which may be mono- to tri-substituted by identical or different radicals selected from the group consisting of fluorine, chlorine, bromine, nitro, cyano, aminocarbonylamino, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl, phenoxy, chlorophenoxy, fluorophenoxy, carbalkoxy having 1 to 4 carbon atoms in the alkoxy group and piperazinyl, which in turn may be substituted by alkyl having 1 or 2 carbon atoms, or

R⁷ represents naphthylalkyl having 1 to 4 carbon atoms in the alkyl group, or

R⁷ represents phenylalkyl having 1 to 6 carbon atoms in the alkyl group, wherein the phenyl group may be mono- to tri-substituted by identical or different radicals selected from the group consisting of fluorine, chlorine, bromine, nitro, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl, phenylalkoxy having 1 to 4 carbon atoms in the alkoxy group, alkylthio having 1 to 4 carbon atoms and phenoxy, which in turn may be substituted by 1 to 3 radicals selected from fluorine, chlorine, methyl, ethyl, methylthio, ethylthio and/or dialkylamino having 1 or 2 carbon atoms in each alkyl group, or

R⁷ represents phenyloxyalkyl having 1 to 4 carbon atoms in the oxyalkyl group, wherein the phenyl group may be substituted by 1 to 3 identical or different radicals selected from fluorine, chlorine, methyl and ethyl, or

R⁷ represents phenylalkinyl having 3 to 6 carbon atoms in the alkinyl group, wherein the phenyl group may be substituted by 1 to 3 identical or different radicals selected from fluorine, chlorine, methyl and ethyl, or

R⁷ represents 5- or 6-membered heterocyclyl having 1 to 3 heteroatoms, such as nitrogen, sulphur and/or oxygen, wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy, which in turn may be substituted by 1 to 3 fluorine and/or chlorine atoms, or

R⁷ represents 5- or 6-membered heterocyclylalkyl having 1 to 4 carbon atoms in the alkyl group and 1 to 3 heteroatoms, such as nitrogen, sulphur and/or oxygen, in the heterocyclyl group wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy,

R⁴ represents a group selected from —OR⁸, —SR⁹ and —NH—R¹⁰,

wherein

R⁸ represents hydrogen, straight-chain or branched alkyl having 1 to 6 carbon atoms, halogenoalkyl having 1 to 6 carbon atoms and 1 to 5 fluorine, chlorine and/or bromine atoms, alkoxyalkyl having 1 to 4 carbon atoms in the alkyl group and 1 to 4 carbon atoms in each alkoxy group, halogenoalkoxyalkyl having 1 to 4 carbon atoms in the alkyl group and 1 to 6 carbon atoms and 1 to 5 fluorine and/or chlorine atoms in the halogenoalkoxy group, halogenoalkoxyalkoxy-alkyl having 1 to 4 carbon atoms in the alkyl group, 1 to 4 carbon atoms in the alkoxy group and 1 to 6 carbon atoms as well as 1 to 5 fluorine and/or chlorine atoms in the halogenoalkoxy group, alkinyl having 3 to 6 carbon atoms, or

R⁸ represents cycloalkyl having 3 to 6 carbon atoms, wherein each of these groups may be substituted by 1 to 3 identical or different radicals selected from alkyl having 1 or 2 carbon atoms and alkoxy having 1 or 2 carbon atoms, or wherein the cycloalkyl group may contain a fused phenyl ring, which in turn may be substituted by 1 to 3 identical or different radicals selected from alkyl having 1 or 2 carbon atoms and alkoxy having 1 or 2 carbon atoms, or

R⁸ represents phenyl, which may be mono- to tri-substituted by identical or different radicals selected from the group consisting of fluorine, chlorine, bromine, nitro, cyano, aminocarbonylamino, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl, phenoxy, chlorophenoxy, fluorophenoxy, carbalkoxy having 1 to 4 carbon atoms in the alkoxy group and piperazinyl, which in turn may be substituted by alkyl having 1 or 2 carbon atoms, or

R⁸ represents naphthylalkyl having 1 to 4 carbon atoms in the alkyl group, or

R⁸ represents phenylalkyl having 1 to 6 carbon atoms in the alkyl group, wherein the phenyl group may be mono- to tri-substituted by identical or different radicals selected from the group consisting of fluorine, chlorine, bromine, nitro, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl, phenylalkoxy having 1 to 4 carbon atoms in the alkoxy group, alkylthio having 1 to 4 carbon atoms and phenoxy, which in turn may be substituted by 1 to 3 radicals selected from fluorine, chlorine, methyl, ethyl, methylthio, ethylthio and/or dialkylamino having 1 or 2 carbon atoms in each alkyl group, or

R⁸ represents phenyloxyalkyl having 1 to 4 carbon atoms in the oxyalkyl group, wherein the phenyl group may be substituted by 1 to 3 identical or different radicals selected from fluorine, chlorine, methyl and ethyl, or

R⁸ represents phenylalkinyl having 3 to 6 carbon atoms in the alkinyl group, wherein the phenyl group may be substituted by 1 to 3 identical or different radicals selected from fluorine, chlorine, methyl and ethyl, or

R⁸ represents 5- or 6-membered heterocyclyl having 1 to 3 heteroatoms, such as nitrogen, sulphur and/or oxygen, wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms; alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy, which in turn may be substituted by 1 to 3 fluorine and/or chlorine atoms, or

R⁸ represents 5- or 6-membered heterocyclylalkyl having 1 to 4 carbon atoms in the alkyl group and 1 to 3 heteroatoms, such as nitrogen, sulphur and/or oxygen, in the heterocyclyl group wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy,

R⁹ represents hydrogen, straight-chain or branched alkyl having 1 to 6 carbon atoms, halogenoalkyl having 1 to 6 carbon atoms and 1 to 5 fluorine, chlorine and/or bromine atoms, alkoxyalkyl having 1 to 4 carbon atoms in the alkyl group and 1 to 4 carbon atoms in each alkoxy group, halogenoalkoxyalkyl having 1 to 4 carbon atoms in the alkyl group and 1 to 6 carbon atoms and 1 to 5 fluorine and/or chlorine atoms in the halogenoalkyl group, halogenoalkoxyalkoxyalkyl having 1 to 4 carbon atoms in the alkyl group, 1 to 4 carbon atoms in the alkoxy group and 1 to 6 carbon atoms as well as 1 to 5 fluorine and/or chlorine atoms in the halogenoalkoxy group, alkinyl having 3 to 6 carbon atoms, or

R⁹ represents cycloalkyl having 3 to 6 carbon atoms, wherein each of these groups may be substituted by 1 to 3 identical or different radicals selected from alkyl having 1 or 2 carbon atoms and alkoxy having 1 or 2 carbon atoms, or wherein the cycloalkyl group may contain a fused phenyl ring, which in turn may be substituted by 1 to 3 identical or different radicals selected from alkyl having 1 or 2 carbon atoms and alkoxy having 1 or 2 carbon atoms, or

R⁹ represents phenyl, which may be mono- to tri-substituted by identical or different radicals selected from the group consisting of fluorine, chlorine, bromine, nitro, cyano, aminocarbonylamino, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl, phenoxy, chlorophenoxy, fluorophenoxy, carbalkoxy having 1 to 4 carbon atoms in the alkoxy group and piperazinyl, which in turn may be substituted by alkyl having 1 or 2 carbon atoms, or

R⁹ represents naphthylalkyl having 1 to 4 carbon atoms in the alkyl group, or

R⁹ represents phenylalkyl having 1 to 6 carbon atoms in the alkyl group, wherein the phenyl group may be mono- to tri-substituted by identical or different radicals selected from the group consisting of fluorine, chlorine, bromine, nitro, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl, phenylalkoxy having 1 to 4 carbon atoms in the alkoxy group, alkylthio having 1 to 4 carbon atoms and phenoxy, which in turn may be substituted by 1 to 3 radicals selected from fluorine, chlorine, methyl, ethyl, methylthio, ethylthio and/or dialkylamino having 1 or 2 carbon atoms in each alkyl group, or

R⁹ represents phenyloxyalkyl having 1 to 4 carbon atoms in the oxyalkyl group, wherein the phenyl group may be substituted by 1 to 3 identical or different radicals selected from fluorine, chlorine, methyl and ethyl, or

R⁹ represents phenylalkinyl having 3 to 6 carbon atoms in the alkinyl group, wherein the phenyl group may be substituted by 1 to 3 identical or different radicals selected from fluorine, chlorine, methyl and ethyl, or

R⁹ represents 5- or 6-membered heterocyclyl having 1 to 3 heteroatoms, such as nitrogen, sulphur and/or oxygen, wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy, which in turn may be substituted by 1 to 3 fluorine and/or chlorine atoms, or

R⁹ represents 5- or 6-membered heterocyclylalkyl having 1 to 4 carbon atoms in the alkyl group and 1 to 3 heteroatoms, such as nitrogen, sulphur and/or oxygen, in the heterocyclyl group wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy, and

R¹⁰ represents hydrogen, straight-chain or branched alkyl having 1 to 6 carbon atoms, halogenoalkyl having 1 to 6 carbon atoms and 1 to 5 fluorine, chlorine and/or bromine atoms, alkoxyalkyl having 1 to 4 carbon atoms in the alkyl group and 1 to 4 carbon atoms in each alkoxy group, halogenoalkoxyalkyl having 1 to 4 carbon atoms in the alkyl group and 1 to 6 carbon atoms and 1 to 5 fluorine and/or chlorine atoms in the halogenoalkoxy group, halogenoalkoxy-alkoxy-alkyl having 1 to 4 carbon atoms in the alkyl group, 1 to 4 carbon atoms in the alkoxy group and 1 to 6 carbon atoms as well as 1 to 5 fluorine and/or chlorine atoms in the halogenoalkoxy group, alkinyl having 3 to 6 carbon atoms, or

R¹⁰ represents cycloalkyl having 3 to 6 carbon atoms, wherein each of these groups may be substituted by 1 to 3 identical or different radicals selected from alkyl having 1 or 2 carbon atoms and alkoxy having 1 or 2 carbon atoms, or wherein the cycloalkyl group may contain a fused phenyl ring, which in turn may be substituted by 1 to 3 identical or different radicals selected from alkyl having 1 or 2 carbon atoms and alkoxy having 1 or 2 carbon atoms, or

R¹⁰ represents phenyl, which may be mono- to tri-substituted by identical or different radicals selected from the group consisting of fluorine, chlorine, bromine, nitro, cyano, aminocarbonylamino, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl, phenoxy, chlorophenoxy, fluorophenoxy, carbalkoxy having 1 to 4 carbon atoms in the alkoxy group and piperazinyl, which in turn may be substituted by alkyl having 1 or 2 carbon atoms, or

R¹⁰ represents naphthylalkyl having 1 to 4 carbon atoms in the alkyl group, or

R¹⁰ represents phenylalkyl having 1 to 6 carbon atoms in the alkyl group, wherein the phenyl group may be mono- to tri-substituted by identical or different radicals selected from the group consisting of fluorine, chlorine, bromine, nitro, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl, phenylalkoxy having 1 to 4 carbon atoms in the alkoxy group, alkylthio having 1 to 4 carbon atoms and phenoxy, which in turn may be substituted by 1 to 3 radicals selected from fluorine, chlorine, methyl, ethyl, methylthio, ethylthio and/or dialkylamino having 1 or 2 carbon atoms in each alkyl group, or

R¹⁰ represents phenyloxyalkyl having 1 to 4 carbon atoms in the oxyalkyl group, wherein the phenyl group may be substituted by 1 to 3 identical or different radicals selected from fluorine, chlorine methyl and ethyl, or

R¹⁰ represents phenylalkinyl having 3 to 6 carbon atoms in the alkinyl group, wherein the phenyl group may be substituted by 1 to 3 identical or different radicals selected from fluorine, chlorine, methyl and ethyl, or

R¹⁰ represents 5- or 6-membered heterocyclyl having 1 to 3 heteroatoms, such as nitrogen, sulphur and/or oxygen, wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy, which in turn may be substituted by 1 to 3 fluorine and/or chlorine atoms, or

R¹⁰ represents 5- or 6-membered heterocyclylalkyl having 1 to 4 carbon atoms in the alkyl group and 1 to 3 heteroatoms, such as nitrogen, sulphur and/or oxygen, in the heterocyclyl group wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy, or

R³ and R⁴ also together represent a group of the formula

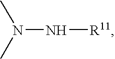

wherein

R¹¹ represents phenyl, which may be mono-to tri-substituted by identical or different radicals selected from the group consisting of fluorine, chlorine, bromine, nitro, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy, or

R³ and R⁴ together represent a group of the formula

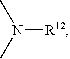

wherein

R¹² represents phenylalkyl having 1 to 4 carbon atoms in the alkyl group, wherein the phenyl group may be substituted by 1 to 3 identical or different radicals selected from the group consisting of fluorine, chlorine, bromine, nitro, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy.

Very particularly preferred are 7-oxabicyclo[2.2.1]heptane derivatives of the formula (I), in which

X represents a group of the formula —CH₂—CH₂— or —CH═CH—,

R¹ represents hydrogen or methyl,

R² represents hydrogen or methyl,

R³ represents a group selected from —OR⁵, —SR⁶ and —NH—R⁷, wherein

R⁵ represents hydrogen, methyl, ethyl, n-propyl, isopropyl, n-butyl, sec-butyl, i-butyl, tert-butyl, halogenoalkyl having 1 to 5 carbon atoms and 1 to 5 fluorine and/or chlorine atoms, alkoxyalkyl having 1 or 2 carbon atoms in the alkyl group and 1 or 2 carbon atoms in each alkoxy group, halogenoalkoxyalkyl having 1 or 2 carbon atoms in the alkyl group and 1 to 6 carbon atoms as well as 1 to 5 fluorine and/or chlorine atoms in the haloalkoxy group, halogenoalkoxyalkoxy-alkyl having 1 or 2 carbon atoms in the alkyl group, 1 or 2 carbon atoms in the alkoxy group and 1 to 6 carbon atoms as well as 1 to 5 fluorine and/or chlorine atoms in the halogenoalkoxy group, alkinyl having 4 to 6 carbon atoms, or

R⁵ represents cycloalkyl having 5 or 6 carbon atoms, wherein each of these groups may be substituted by 1 to 3 identical or different radicals selected from methyl, ethyl, methoxy and ethoxy, or wherein the cycloalkyl group may contain a fused phenyl ring, which in turn may be substituted by 1 to 3 identical or different radicals selected from methyl, ethyl, methoxy and ethoxy, or

R⁵ represents phenyl, which may be mono- to tri-substituted by identical or different radicals selected from the group consisting of fluorine, chlorine, bromine, nitro, cyano, aminocarbonylamino, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chloro-difluoromethoxy, trichloromethoxy, cyclopropyl, cyclopentyl, cyclohexyl, cycloheptyl, phenyl, phenoxy, chlorophenoxy, fluorophenoxy, carbalkoxy having 1 to 4 carbon atoms in the alkoxy group, and piperazinyl, which may be substituted by methyl, or

R⁵ represents naphthylalkyl having 1 or 2 carbon atoms in the alkyl group, or

R⁵ represents phenylalkyl having 1 to 6 carbon atoms in the alkyl group, wherein the phenyl group may be mono- to tri-substituted by identical or different radicals selected from the group consisting of fluorine, chlorine, bromine, nitro, cyano, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chloro difluoromethoxy, trichloromethoxy, cyclopropyl, cyclopentyl, cyclohexyl, cycloheptyl, phenyl, phenylalkoxy having 1 to 4 carbon atoms in the alkoxy group, methylthio, ethylthio, tert-butylthio and phenoxy, which in turn may be substituted by 1 to 3 radicals selected from fluorine, chlorine, methyl, methylthio, dimethylamino and/or diethylamino, or

R⁵ represents phenyloxyalkyl having 1 to 4 carbon atoms in the oxyalkyl group, wherein the phenyl group may be substituted by 1 to 3 identical or different radicals selected from fluorine, chlorine and methyl, or

R⁵ represents phenylalkinyl having 4 to 6 carbon atoms in the alkinyl group, wherein the phenyl group may be substituted by 1 to 3 identical or different radicals selected from fluorine, chlorine and methyl, or

R⁵ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-triazinyl, 1,2,4-triazinyl, 1,3,4-triazinyl, pyridyl, pyrimidinyl, pyrazinyl or pyridazinyl, benzothiazolyl, benzoxazolyl or benzimidazolyl, wherein these heterocyclic groups may be mono- to tri-substituted by identical or different radicals selected from the group consisting of fluorine, chlorine, bromine, nitro, methoxycarbonyl, ethoxycarbonyl, cyano, methyl, ethyl, propyl, isopropyl, n-butyl, iso-butyl, sec.-butyl, tert-butyl, trifluoromethyl, trichloromethyl, chloro-difluoromethyl, methoxy, ethoxy, propoxy, iso-propoxy, n-butoxy, iso-butoxy, sec-butoxy, tert-butoxy, trifluoromethoxy, chloro-difluoromethoxy, trichloromethoxy, cyclopropyl, cyclopentyl, cyclo-hexyl, cycloheptyl, phenyl and phenoxy, which in turn may be substituted by 1 to 3 fluorine and/or chlorine atoms, or

R⁵ represents a group of the formula -A-R¹³,

wherein

A represents straight-chain or branched alkylene having 1 to 4 carbon atoms and

R¹³ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-triazinyl, 1,2,4-triazinyl, 1,3,4-triazinyl, pyridyl, pyrimidinyl, pyrazinyl, pyridazinyl, benzothiazolyl, benzoxazolyl or benzimidazolyl, wherein these heterocyclic groups may be mono- to tri-substituted by identical or different radicals selected from the group consisting of fluorine, chlorine, bromine, nitro, methoxycarbonyl, ethoxycarbonyl, cyano, methyl, ethyl, propyl, isopropyl, n-butyl, iso-butyl, sec.butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoro-methoxy, chloro-difluoromethoxy, trichloromethoxy, cyclopropyl, cyclopentyl, cyclohexyl, cycloheptyl, phenyl and phenoxy,

R⁶ represents hydrogen, methyl, ethyl, n-propyl, isopropyl, n-butyl, sec.-butyl, i-butyl, tert-butyl, halogenoalkyl having 1 to 5 carbon atoms and 1 to 5 fluorine and/or chlorine atoms, alkoxyalkyl having 1 or 2 carbon atoms in the alkyl group and 1 or 2 carbon atoms in each alkoxy group, halogenoalkoxyalkyl having 1 or 2 carbon atoms in the alkyl group and 1 to 6 carbon atoms as well as 1 to 5 fluorine and/or chlorine atoms in the haloalkoxy group, halogenoalkoxyalkoxyalkyl having 1 or 2 carbon atoms in the alkyl group, 1 or 2 carbon atoms in the alkoxy group and 1 to 6 carbon atoms as well as 1 to 5 fluorine and/or chlorine atoms in the halogenoalkoxy group, alkinyl having 4 to 6 carbon atoms, or

R⁶ represents cycloalkyl having 5 or 6 carbon atoms, wherein each of these groups may be substituted by 1 to 3 identical or different radicals selected from methyl, ethyl, methoxy and ethoxy, or wherein the cycloalkyl group may contain a fused phenyl ring, which in turn may be susbstituted by 1 to 3 identical or different radicals selected from methyl, ethyl, methoxy and ethoxy, or

R⁶ represents phenyl, which may be mono- to tri-substituted by identical or different radicals selected from the group consisting of fluorine, chlorine, bromine, nitro, cyano, aminocarbonylamino, methyl, ethyl, propyl, isopropyl, n-butyl, iso-butyi, sec.-butyi, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chloro-difluoro-methoxy, trichloromethoxy, cyclopropyl, cyclopentyl, cyclohexyl, cycloheptyl, phenyl, phenoxy, chlorophenoxy, fluorophenoxy, carbalkoxy having 1 to 4 carbon atoms in the alkoxy group, and piperazinyl, which may be substituted by methyl, or

R⁶ represents naphthylalkyl having 1 or 2 carbon atoms in the alkyl group, or

R⁶ represents phenylalkyl having 1 to 6 carbon atoms in the alkyl group, wherein the phenyl group may be mono- to tri-substituted by identical or different radicals selected from the group consisting of fluorine, chlorine, bromine, nitro, cyano, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chloro difluoromethoxy, trichloromethoxy, cyclopropyl, cyclopentyl, cyclohexyl, cycloheptyl, phenyl, phenylalkoxy having 1 to 4 carbon atoms in the alkoxy group, methylthio, ethylthio, tert-butylthio, and phenoxy, which in turn may be substituted by 1 to 3 radicals selected from fluorine, chlorine, methyl, methylthio, dimethylamino and/or diethylamino, or

R⁶ represents phenyloxyalkyl having 1 to 4 carbon atoms in the oxyalkyl group, wherein the phenyl group may be substituted by 1 to 3 identical or different radicals selected from fluorine, chlorine and methyl, or

R⁶ represents phenylalkinyl having 4 to 6 carbon atoms in the alkenyl group, wherein the phenyl group may be substituted by 1 to 3 identical or different radicals selected from fluorine, chlorine and methyl, or

R⁶ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-triazinyl, 1,2,4-triazinyl, 1,3,4-triazinyl, pyridyl, pyrimidinyl, pyrazinyl, pyridazinyl, benzothiazolyl, benzoxazolyl or benzimidazolyl, wherein these heterocyclic groups may be mono- to tri-substituted by identical or different radicals selected from the group consisting of fluorine, chlorine, bromine, nitro, methoxycarbonyl, ethoxycarbonyl, cyano, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chloro difluoromethoxy, trichloromethoxy, cyclopropyl, cyclopentyl, cyclohexyl, cycloheptyl, phenyl and phenoxy, which in turn may be substituted by 1 to 3 fluorine and/or chlorine atoms, or

R⁶ represents a group of the formula -A-R³,

wherein

A represents straight-chain or branched alkylene having 1 to 4 carbon atoms and

R¹³ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-triazinyl, 1,2,4-triazinyl, 1,3,4-triazinyl, pyridyl, pyrimidinyl, pyrazinyl, pyridazinyl, benzothiazolyl, benzoxazolyl or benzimidazolyl, wherein these heterocyclic groups may be mono- to tri-substituted by identical or different radicals selected from the group consisting of fluorine, chlorine, bromine, nitro, methoxycarbonyl, ethoxycarbonyl, cyano, methyl, ethyl, propyl, isopropyl, n-butyl, iso-butyl, sec.-butyl, tert-butyl, trifluoromethyl, trichloromethyl, chloro-difluoromethyl, methoxy, ethoxy, propoxy, iso-propoxy, n-butoxy, iso-butoxy, sec-butoxy tert-butoxy, trifluoromethoxy, chlorodifluoromethoxy, trichloromethoxy, cyclopropyl, cyclopentyl, cyclohexyl, cycloheptyl, phenyl and phenoxy, and

R⁷ represents hydrogen, methyl, ethyl, n-propyl, isopropyl, n-butyl, sec-butyl, i-butyl or tert-butyl, halogenoalkyl having 1 to 5 carbon atoms and 1 to 5 fluorine and/or chlorine atoms alkoxyalkyl having 1 or 2 carbon atoms in the alkyl group and 1 or 2 carbon atoms in each alkoxy group, halogenoalkoxyalkyl having 1 or 2 carbon atoms in the alkyl group and 1 to 6 carbon atoms as well as 1 to 5 fluorine and/or chlorine atoms in the haloalkoxy group, halogenoalkoxyalkoxyalkyl having 1 or 2 carbon atoms in the alkyl group, 1 or 2 carbon atoms in the alkoxy group and 1 to 6 carbon atoms as well as 1 to 5 fluorine and/or chlorine atoms in the hologenoalkoxy group, alkinyl having 4 to 6 carbon atoms, or

R⁷ represents cycloalkyl having 5 or 6 carbon atoms, wherein each of these groups may be substituted by 1 to 3 identical or different radicals selected from methyl, ethyl, methoxy and ethoxy, or wherein the cycloalkyl group may contain a fused phenyl ring, which in turn may be substituted by 1 to 3 identical or different radicals selected from methyl, ethyl, methoxy and ethoxy, or

R⁷ represents phenyl, which may be mono- to tri-substituted by identical or different radicals selected from the group consisting of fluorine, chlorine, bromine, nitro, cyano, aminocarbonylamino, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chloro-difluoro-methoxy, trichloromethoxy, cyclopropyl, cyclopentyl, cyclohexyl, cycloheptyl, phenyl, phenoxy, chlorophenoxy, fluorophenoxy, carbalkoxy having 1 to 4 carbon atoms in the alkoxy group, and piperazinyl, which may be substituted by methyl, or

R⁷ represents naphthylalkyl having 1 or 2 carbon atoms in the alkyl group, or

R⁷ represents phenylalkyl having 1 to 6 carbon atoms in the alkyl group, wherein the phenyl group may be mono- to tri-substituted by identical or different radicals selected from the group consisting of fluorine, chlorine, bromine, nitro, cyano, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chloro-difluoromethoxy, trichloromethoxy, cyclopropyl, cyclopentyl, cyclohexyl, cycloheptyl, phenyl, phenylalkoxy having 1 to 4 carbon atoms in the alkoxy group, methylthio, ethylthio, tert-butylthio, and phenoxy, which in turn may be substituted by 1 to 3 radicals selected from fluorine, chlorine, methyl, methylthio, dimethylamino and/or diethylamino, or

R⁷ represents phenyloxyalkyl having 1 to 4 carbon atoms in the oxyalkyl group, wherein the phenyl group may be substituted by 1 to 3 identical or different radicals selected from fluorine, chlorine and methyl, or

R⁷ represents phenylalkinyl having 4 to 6 carbon atoms in the alkinyl group, wherein the phenyl group may be substituted by 1 to 3 identical or different radicals selected from fluorine, chlorine and methyl, or

R⁷ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-triazinyl, 1,2,4-triazinyl, 1,3,4-triazinyl, pyridyl, pyrimidinyl, pyrazinyl, pyridazinyl, benzothiazolyl, benzoxazolyl or benzimidazolyl, wherein these heterocyclic groups may be mono- to tri-substituted by identical or different radicals selected from the group consisting of fluorine, chlorine, bromine, nitro, methoxycarbonyl, ethoxycarbonyl, cyano, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chloro difluoromethoxy, trichloromethoxy, cyclopropyl, cyclopentyl, cyclohexyl, cycloheptyl, phenyl and phenoxy, which in turn may be substituted by 1 to 3 fluorine and/or chlorine atoms, or

R⁷ represents a group of the formula -A-R¹³,

wherein

A represents straight-chain or branched alkylene having 1 to 4 carbon atoms and

R¹³ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-triazinyl, 1,2,4-triazinyl, 1,3,4-triazinyl, pyridyl, pyrimidinyl, pyrazinyl, pyridazinyl, benzothiazolyl, benzoxazolyl or benzimidazolyl, wherein these heterocyclic groups may be mono- to tri-substituted by identical or different radicals selected from the group consisting of fluorine, chlorine, bromine, nitro, methoxycarbonyl, ethoxycarbonyl, cyano, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, n-butoxy, iso-butoxy, sec-butoxy, tert-butoxy, trifluoromethoxy, chloro difluoromethoxy, trichloromethoxy, cyclopropyl, cyclopentyl, cyclohexyl, cycloheptyl, phenyl and phenoxy, and

R⁴ represents a group selected from —OR⁸, —SR⁹ and —NH—R¹⁰, wherein

R⁸ represents hydrogen, methyl, ethyl, n-propyl, isopropyl, n-butyl, sec-butyl, i-butyl, tert-butyl, halogenoalkyl having 1 to 5 carbon atoms and 1 to 5 fluorine and/or chlorine atoms, alkoxyalkyl having 1 or 2 carbon atoms in the alkyl group and 1 or 2 carbon atoms in each alkoxy group, halogenoalkoxyalkyl having 1 or 2 carbon atoms in the alkyl group and 1 to 6 carbon atoms as well as 1 to 5 fluorine and/or chlorine atoms in the haloalkoxy group, halogenoalkoxyalkoxyalkyl having 1 or 2 carbon atoms in the alkyl group, 1 or 2 carbon atoms in the alkoxy group and 1 to 6 carbon atoms as well as 1 to 5 fluorine and/or chlorine atoms in the halogenoalkoxy group, alkinyl having 4 to 6 carbon atoms, or

R⁸ represents cycloalkyl having 5 or 6 carbon atoms, wherein each of these groups may be substituted by 1 to 3 identical or different radicals selected from methyl, ethyl, methoxy and phenyl ring, which in turn may be substituted by 1 to 3 identical or different radicals selected from methyl, ethyl, methoxy and ethoxy, or

R⁸ represents phenyl, which may be mono- to tri-substituted by identical or different radicals selected from the group consisting of fluorine, chlorine, bromine, nitro, cyano, aminocarbonylamino, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chlorodifluoro-methoxy, trichloromethoxy, cyclopropyl, cyclopentyl, cyclohexyl, cycloheptyl, phenyl, phenoxy, chlorophenoxy, fluorophenoxy, carbalkoxy having 1 to 4 carbon atoms in the alkoxy group, and piperazinyl, which may be substituted by methyl, or

R⁸ represents naphthylalkyl having 1 or 2 carbon atoms in the alkyl group, or

R⁸ represents phenylalkyl having 1 to 6 carbon atoms in the alkyl group, wherein the phenyl group may be mono- to tri-substituted by identical or different radicals selected from the group consisting of fluorine, chlorine, bromine, nitro, cyano, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chloro difluoromethoxy, trichloromethoxy, cyclopropyl, cyclopentyl, cyclohexyl, cycloheptyl, phenyl, phenylalkoxy having 1 to 4 carbon atoms in the alkoxy group, methylthio, ethylthio, tertbutylthio and phenoxy, which in turn may be substituted by 1 to 3 radicals selected from fluorine, chlorine, methyl, methylthio, dimethylamino and/or diethylamino, or

R⁸ represents phenyloxyalkyl having 1 to 4 carbon atoms in the oxyalkyl group, wherein the phenyl group may be substituted by 1 to 3 identical or different radicals selected from fluorine, chlorine and methyl, or

R⁸ represents phenylalkinyl having 4 to 6 carbon atoms in the alkinyl group, wherein the phenyl group may be substituted by 1 to 3 identical or different radicals selected from fluorine, chlorine and methyl, or

R⁸ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-triazinyl, 1,2,4-triazinyl, 1,3,4-triazinyl, pyridyl, pyrimidinyl, pyrazinyl, pyridazinyl, benzothiazolyl, benzoxazolyl or benzimidazolyl, wherein these heterocyclic groups may be mono- to tri-substituted by identical or different radicals selected from the group consisting of fluorine, chlorine, bromine, nitro, methoxycarbonyl, ethoxycarbonyl, cyano, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chloro difluoromethoxy, trichloromethoxy, cyclopropyl, cyclopentyl, cyclohexyl, cycloheptyl, phenyl and phenoxy, which in turn may be substituted by 1 to 3 fluorine and/or chlorine atoms, or

R⁸ represents a group of the formula -A-R¹³

wherein

A represents straight-chain or branched alkylene having 1 to 4 carbon atoms and

R¹³ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-triazinyl, 1,2,4-triazinyl, 1,3,4-triazinyl, pyridyl, pyrimidinyl, pyrazinyl, pyridazinyl, benzothiazolyl, benzoxazolyl or benzimidazolyl, wherein these heterocyclic groups may be mono- to tri-substituted by identical or different radicals selected from the group consisting of fluorine, chlorine, bromine, nitro, methoxycarbonyl, ethoxycarbonyl, cyano, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoro-methoxy, chloro difluoromethoxy, trichloromethoxy, cyclopropyl, cyclopentyl, cyclohexyl cycloheptyl, phenyl and phenoxy,

R⁹ represents hydrogen, methyl, ethyl, n-propyl, isopropyl, n-butyl, sec-butyl, i-butyl, tert-butyl, halogenoalkyl having 1 to 5 carbon atoms and 1 to 5 fluorine and/or chlorine atoms, alkoxyalkyl having 1 or 2 carbon atoms in the alkyl group and 1 or 2 carbon atoms in each alkoxy group, halogenoalkoxyalkyl having 1 or 2 carbon atoms in the alkyl group and 1 to 6 carbon atoms as well as 1 to 5 fluorine and/or chlorine atoms in the haloalkoxy group, halogenoalkoxyalkoxyalkyl having 1 or 2 carbon atoms in the alkyl group, 1 or 2 carbon atoms in the alkoxy group and 1 to 6 carbon atoms as well as 1 to 5 fluorine and/or chlorine atoms in the halogenoalkoxy group, alkinyl having 4 to 6 carbon atoms, or

R⁹ represents cycloalkyl having 5 or 6 carbon atoms, wherein each of these groups may be substituted by 1 to 3 identical or different radicals selected from methyl, ethyl, methoxy and ethoxy, or wherein the cycloalkyl group may contain a fused phenyl ring, which in turn may be substituted by 1 to 3 identical or different radicals selected from methyl, ethyl, methoxy and ethoxy, or

R⁹ represents phenyl, which may be mono- to tri-substituted by identical or different radicals selected from the group consisting of fluorine, chlorine, bromine, nitro, cyano, aminocarbonylamino, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chloro difluoromethoxy, trichloromethoxy, cyclopropyl, cyclopentyl, cyclohexyl, cycloheptyl, phenyl, phenoxy, chlorophenoxy, fluorophenoxy, carbalkoxy having 1 to 4 carbon atoms in the alkoxy group, and piperazinyl, which may be substituted by methyl, Or

R⁹ represents naphthylalkyl having 1 or 2 carbon atoms in the alkyl group, or

R⁹ represents phenylalkyl having 1 to 6 carbon atoms in the alkyl group, wherein the phenyl group may be mono- to tri-substituted by identical or different radicals selected from the group consisting of fluorine, chlorine, bromine, nitro, cyano, methyl, ethyl, propyl, isopropyl, n-butyl, iso-butyl, sec.-butyl, tert-butyl, trifluoromethyl, trichloromethyl, chloro difluoromethyl, methoxy, ethoxy, propoxy, iso-propoxy, n-butoxy, iso-butoxy, sec-butoxy, tert-butoxy, trifluoromethoxy, chloro difluoromethoxy, trichloromethoxy, cyclopropyl, cyclopentyl, cyclohexyl, cycloheptyl, phenyl, phenylalkoxy having 1 to 4 carbon atoms in the alkoxy group, methylthio, ethylthio, tert-butylthio, and phenoxy, which in turn may be substituted by 1 to 3 radicals selected from fluorine, chlorine, methyl, methylthio, dimethylamino and/or diethylamino, or

R⁹ represents phenyloxyalkyl having 1 to 4 carbon atoms in the oxyalkyl group, wherein the phenyl group may be substituted by 1 to 3 identical or different radicals selected from fluorine, chlorine and methyl, or

R⁹ represents phenylalkinyl having 4 to 6 carbon atoms in the alkinyl group, wherein the phenyl group may be substituted by 1 to 3 identical or different radicals selected from fluorine, chlorine and methyl, or

R⁹ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-triazinyl, 1,2,4-triazinyl, 1,3,4-triazinyl, pyridyl, pyrimidinyl, pyrazinyl, pyridazinyl, benzothiazolyl, benzoxazolyl or benzimidazolyl, wherein these heterocyclic groups may be mono- to tri-substituted by identical or different radicals selected from the group consisting of fluorine, chlorine, bromine, nitro, methoxycarbonyl, ethoxycarbonyl, cyano, methyl, ethyl, propyl, isopropyl, n-butyl, iso-butyl, sec.-butyl, tert-butyl, trifluoromethyl, trichloromethyl, chloro difluoromethyl, methoxy, ethoxy, propoxy, iso-propoxy, n-butoxy, iso-butoxy, sec-butoxy, tert-butoxy, trifluoromethoxy, chloro difluoromethoxy, trichloromethoxy, cyclopropyl, cyclopentyl, cyclohexyl, cycloheptyl, phenyl and phenoxy, which in turn may be substituted by 1 to 3 fluorine and/or chlorine atoms, or

R⁹ represents a group of the formula -A-R¹³,

wherein

A represents straight-chain or branched alkylene having 1 to 4 carbon atoms and

R¹³ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-triazinyl, 1,2,4-triazinyl, 1,3,4-triazinyl, pyridyl, pyrimidinyl, pyrazinyl or pyridazinyl, benzothiazolyl, benzoxazolyl or benzimidazolyl, wherein these heterocyclic groups may be mono- to tri-substituted by identical or different radicals selected from the group consisting of fluorine, chlorine, bromine, nitro, methoxycarbonyl, ethoxycarbonyl, cyano, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoro-methoxy, chloro difluoromethoxy, trichloromethoxy, cyclopropyl, cyclopentyl, cyclohexyl, cycloheptyl, phenyl and phenoxy, and

R¹⁰ represents hydrogen, methyl, ethyl, n-propyl, isopropyl, n-butyl, sec-butyl, i-butyl, tert-butyl, halogenoalkyl having 1 to 5 carbon atoms and 1 to 5 fluorine and/or chlorine atoms, alkoxyalkyl having 1 or 2 carbon atoms in the alkyl group and 1 or 2 carbon atoms in each alkoxy group, halogenoalkoxyalkyl having 1 or 2 carbon atoms in the alkyl group and 1 to 6 carbon atoms as well as 1 to 5 fluorine and/or chlorine atoms in the haloalkoxy group, halogenoalkoxyalkoxyalkyl having 1 or 2 carbon atoms in the alkyl group, 1 or 2 carbon atoms in the alkoxy group and 1 to 6 carbon atoms as well as 1 to 5 fluorine and/or chlorine atoms in the halogenoalkoxy group, alkinyl having 4 to 6 carbon atoms, or

R¹⁰ represents cycloalkyl having 5 or 6 carbon atoms, wherein each of these groups may be substituted by 1 to 3 identical or different radicals selected from methyl, ethyl, methoxy and ethoxy, or wherein the cycloalkyl group may contain a fused phenyl ring, which in turn may be substituted by 1 to 3 identical or different radicals selected from methyl, ethyl, methoxy and ethoxy, or

R¹⁰ represents phenyl which may be mono- to tri-substituted by identical or different radicals selected from the group consisting of fluorine, chlorine, bromine, nitro, cyano, aminocarbonylamino, methyl, ethyl, propyl, isopropyl, n-butyl, iso-butyl, sec.-butyl, tert-butyl, trifluoromethyl, trichloromethyl, chloro difluoromethyl, methoxy, ethoxy, propoxy, iso-propoxy, n-butoxy, iso-butoxy, sec-butoxy, tert-butoxy, trifluoromethoxy, chloro difluoro-methoxy, trichloromethoxy, cyclopropyl, cyclopentyl, cyclohexyl, cycloheptyl, phenyl, phenoxy, chlorophenoxy, fluorophenoxy, carbalkoxy having 1 to 4 carbon atoms in the alkoxy group, and piperazinyl, which may be substituted by methyl, or

R¹⁰ represents naphthylalkyl having 1 or 2 carbon atoms in the alkyl group, or

R¹⁰ represents phenylalkyl having 1 to 6 carbon atoms in the alkyl group, wherein the phenyl group may be mono- to tri-substituted by identical or different radicals selected from the group consisting of fluorine, chlorine, bromine, nitro, cyano, methyl, ethyl, propyl, isopropyl, n-butyl, iso-butyl, sec.-butyl, tert-butyl, trifluoromethyl, trichloromethyl, chloro difluoromethyl, methoxy, ethoxy, propoxy, iso-propoxy, n-butoxy, iso-butoxy, sec.-butoxy, tert-butoxy, trifluoromethoxy, chloro difluoromethoxy, trichloromethoxy, cyclopropyl, cyclopentyl, cyclohexyl, cycloheptyl, phenyl, phenylalkoxy having 1 to 4 carbon atoms in the alkoxy group, methylthio, ethylthio, tert-butylthio and phenoxy, which in turn may be substituted by 1 to 3 radicals selected from fluorine, chlorine, methyl, methylthio, dimethylamino and/or diethylamino, or

R¹⁰ represents phenyloxyalkyl having 1 to 4 carbon atoms in the oxyalkyl group, wherein the phenyl group may be substituted by 1 to 3 identical or different radicals selected from fluorine, chlorine and methyl, or

R¹⁰ represents phenylalkinyl having 4 to 6 carbon atoms in the alkinyl group, wherein the phenyl group may be substituted by 1 to 3 identical or different radicals selected from fluorine, chlorine and methyl, or

R¹⁰ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-triazinyl, 1,2,4-triazinyl, 1,3,4-triazinyl, pyridyl, pyrimidinyl, pyrazinyl, pyridazinyl, benzothiazolyl, benzoxazolyl or benzimidazolyl, wherein these heterocyclic groups may be mono- to tri-substituted by identical or different radicals selected from the group consisting of fluorine, chlorine, bromine, nitro, methoxycarbonyl, ethoxycarbonyl, cyano, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chloro difluoromethoxy, trichloromethoxy, cyclopropyl, cyclopentyl, cyclohexyl, cycloheptyl, phenyl and phenoxy, which in turn may be substituted by 1 to 3 fluorine and/or chlorine atoms, or

R¹⁰ represents a group of the formula -A-R¹³, wherein

A represents straight-chain or branched alkylene having 1 to 4 carbon atoms and

R¹³ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-triazinyl, 1,2,4-triazinyl, 1,3,4-triazinyl, pyridyl, pyrimidinyl, pyrazinyl, pyridazinyl, benzothiazolyl, benzoxazolyl or benzimidazolyl, wherein these heterocyclic groups may be mono- to tri-substituted by identical or different radicals selected from the group consisting of fluorine, chlorine, bromine, nitro, methoxycarbonyl, ethoxycarbonyl, cyano, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoro-methoxy, chloro difluoromethoxy, trichloromethoxy, cyclopropyl, cyclopentyl, cyclohexyl, cycloheptyl, phenyl and phenoxy, or

R³ and R⁴ also together represent a group of the formula

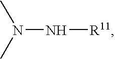

wherein

R¹¹ represents phenyl, which may be mono- to tri-substituted by identical or different radicals selected from the group consisting of fluorine, chlorine, bromine, nitro, cyano, methyl, ethyl, propyl, isopropyl, n-butyl, iso-butyl, sec.-butyl, tert-butyl, trifluoromethyl, trichloromethyl, chloro difluoromethyl, methoxy, ethoxy, propoxy, iso-propoxy, n-butoxy, iso-butoxy, sec-butoxy, tert-butoxy, trifluoromethoxy, chlorodifluoromethoxy, trichloromethoxy, cyclopropyl, cyclopentyl, cyclohexyl, cycloheptyl, phenyl and phenoxy, or

R³ and R⁴ together represent a group of the formula

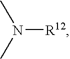

wherein

R¹² represents phenylalkyl having 1 or 2 carbon atoms in the alkyl group, wherein the phenyl group may be substituted by 1 to 3 identical or different radicals selected from the group consisting of fluorine, chlorine, bromine, nitro, cyano, methyl, ethyl, propyl, isopropyl, n-butyl, iso-butyl, sec.-butyl, tert-butyl, trifluoromethyl, trichloromethyl, chloro difluoromethyl, methoxy, ethoxy, propoxy, iso-propoxy, n-butoxy, iso-butoxy, sec-butoxy, tert-butoxy, trifluoromethoxy, chloro difluoromethoxy, trichloromethoxy, cyclopropyl, cyclopentyl, cyclohexyl, cycloheptyl, phenyl and phenoxy.

The 7-oxabicyclo[2.2.1]heptane derivatives of the formula (I), which can be used according to the invention, are known in some cases (cf. J. Mol. Catal. 90, 143-156 (1994), ACS Symp. Ser. 640 364-380 (1996) and J. Chem. Educ. 76, 659-660 (1999)).

New 7-oxabicyclo[2.2.1]heptane derivatives are those compounds of the formula

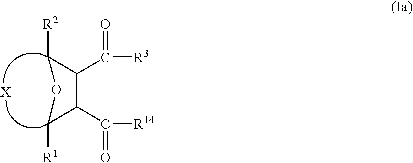

in which

X represents a group of the formula —CH₂—CH₂— or —CH═CH—,

R¹ and R², independently of one another, represent hydrogen or methyl,

R³ represents a group selected from —OR⁵, —SR⁶ and —NH—R⁷, wherein

R⁵, R⁶ and R⁷, independently of one another, represent hydrogen, alkyl, halogenoalkyl, alkoxyalkyl, halogenoalkoxyalkyl, alkinyl, optionally substituted cycloalkyl, optionally substituted aryl, optionally substituted aralkyl, optionally substituted aryloxyalkyl, optionally substituted arylakinyl, optionally substituted heterocyclyl or optionally substituted heterocyclylalkyl, and

R¹⁴ represents a group selected from —SR⁹ and —NH—R¹⁰, wherein

R⁹ represents hydrogen straight-chain or branched alkyl having 1 to 8 carbon atoms, halogenoalkyl having 1 to 8 carbon atoms and 1 to 6 halogen atoms, alkoxyalkyl having 1 to 6 carbon atoms in the alkyl group and 1 to 6 carbon atoms in each alkoxy group, halogenoalkoxyalkyl having 1 to 6 carbon atoms in the alkyl group and 1 to 6 carbon atoms as well as 1 to 6 halogen atoms in each halogenoalkoxy group, alkinyl having 3 to 8 carbon atoms, or

R⁹ represents cycloalkyl having 3 to 7 carbon atoms, wherein each of these groups may be mono- to tri-substituted by identical or different radicals selected from alkyl having 1 to 4 carbon atoms and alkoxy having 1 to 4 carbon atoms, or wherein the cycloalkyl group may contain a fused phenyl ring, which in turn may be substituted by one to three identical or different radicals selected from alkyl having 1 to 4 carbon atoms and alkoxy having 1 to 4 carbon atoms, or

R⁹ represents aryl having 6 to 10 carbon atoms, wherein each of these groups may be mono- to tri-substituted by identical or different radicals selected from the group consisting of halogen, nitro, cyano, aminocarbonylamino, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenoxy, halophenoxy, carbalkoxy having 1 to 6 carbon atoms in the alkoxy group, and piperazinyl, which in turn may be substituted by alkyl having 1 to 4 carbon atoms, or

R⁹ represents arylalkyl having 6 to 10 carbon atoms in the aryl group and 1 to 6 carbon atoms in the alkyl group, wherein each of these groups may be mono- to tri-substituted by identical of different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenylalkoxy having 1 to 4 carbon atoms in the alkoxy turn may be substituted by halogen, alkyl having 1 to 4 carbon atoms, alkylthio having 1 to 4 carbon atoms and/or dialkylamino having 1 to 4 carbon atoms in each alkyl group, or

R⁹ represents aryloxyalkyl having 6 to 10 carbon atoms in the aryloxy group and 1 to 4 carbon atoms in the alkyl group, wherein the aryloxy group may be substituted by 1 to 3 identical or different radicals selected from halogen and alkyl having 1 to 4 carbon atoms, or

R⁹ represents arylalkinyl having 6 to 10 carbon atoms in the aryl group and 3 to 6 carbon atoms in the alkinyl group, wherein the aryl group may be substituted by 1 to 3 identical or different radicals selected from halogen and alkyl having 1 to 4 carbon atoms, or

R⁹ represents 5- or 6-membered heterocyclyl having 1 to 3 heteroatoms, such as nitrogen, sulphur and/or oxygen, wherein the heterocyclic groups may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy, which in turn may be substituted by 1 to 3 halogen atoms, or

R⁹ represents 5- or 6-membered heterocyclylalkyl having 1 to 6 carbon atoms in the alkyl group and 1 to 3 heteroatoms, such as nitrogen, sulphur and/or oxygen, in the heterocyclyl group wherein the heterocyclyl groups may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy, and

R¹⁰ represents hydrogen, straight-chain or branched alkyl having 1 to 8 carbon atoms, halogenoalkyl having 1 to 8 carbon atoms and 1 to 6 halogen atoms, alkoxyalkyl having 1 to 6 carbon atoms in the alkyl group and 1 to 6 carbon atoms in each alkoxy group, halogenoalkoxyalkyl having 1 to 6 carbon atoms in the alkyl group and 1 to 6 carbon atoms as well as 1 to 6 halogen atoms in each halogenoalkoxy group, alkinyl having 3 to 8 carbon atoms, or

R¹⁰ represents cycloalkyl having 3 to 7 carbon atoms, wherein each of these groups may be mono- to tri-substituted by identical or different radicals selected from alkyl having 1 to 4 carbon atoms and alkoxy having 1 to 4 carbon atoms, or wherein the cycloalkyl group may contain a fused phenyl ring, which in turn may be substituted by one to three identical or different radicals selected from alkyl having 1 to 4 carbon atoms and alkoxy having 1 to 4 carbon atoms, or

R¹⁰ represents aryl having 6 to 10 carbon atoms, wherein each of these groups may be mono- to tri-substituted by identical or different radicals selected from the group consisting of halogen, nitro, cyano, aminocarbonylamino, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenoxy, halophenoxy, carbalkoxy having 1 to 6 carbon atoms in the alkoxy group, and piperazinyl, which in turn may be substituted by alkyl having 1 to 4 carbon atoms, or

R¹⁰ represents arylalkyl having 6 to 10 carbon atoms in the aryl group and 1 to 6 carbon atoms in the alkyl group, wherein each of these groups may be mono- to tri-substituted by identical of different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical of different halogen atoms, cycloalkyl having 3 to 8 carbon atoms, phenyl, phenylalkoxy having 1 to 4 carbon atoms in the alkoxy group, alkylthio having 1 to 6 carbon atoms and phenoxy, which in turn may be substituted by halogen, alkyl having 1 to 4 carbon atoms, alkylthio having 1 to 4 carbon atoms and/or dialkylamino having 1 to 4 carbon atoms in each alkyl group, or

R¹⁰ represents aryloxyalkyl having 6 to 10 carbon atoms in the aryloxy group and 1 to 4 carbon atoms in the alkyl group, wherein the aryloxy group may be substituted by 1 to 3 identical or different radicals selected from halogen and alkyl having 1 to 4 carbon atoms, or

R¹⁰ represents arylalkinyl having 6 to 10 carbon atoms in the aryl group and 3 to 6 carbon atoms in the alkinyl group, wherein the aryl group may be substituted by 1 to 3 identical or different radicals selected from halogen and alkyl having 1 to 4 carbon atoms, or

R¹⁰ represents 5 or 6-membered heterocyclyl having 1 to 3 heteroatoms, such as nitrogen, sulphur and/or oxygen, wherein the heterocyclic groups may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy, which in turn may be substituted by 1 to 3 halogen atoms, or

R¹⁰ represents 5- or 6-membered heterocyclylalkyl having 1 to 6 carbon atoms in the alkyl group and 1 to 3 heteroatoms, such as nitrogen, sulphur and/or oxygen, in the heterocyclyl group, wherein the heterocyclyl groups may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy, or

R³ and R¹⁴ also together represent a group of the formula

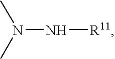

wherein

R¹¹ represents aryl having 6 to 10 carbon atoms, wherein each of these groups may be mono- to tri-substituted by identical or different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy, or

R³ and R¹⁴ represent a group of the formula

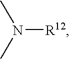

wherein

R¹² represents aralkyl having 6 to 10 carbon atoms in the aryl group and 1 to 4 carbon atoms in the alkyl group, wherein the aryl group may be substituted by 1 to 3 identical of different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy.

The 7-oxabicyclo[2.2.1]heptane derivatives of the formula (Ia) can be prepared by

a) reacting acid anhydrides of the formula

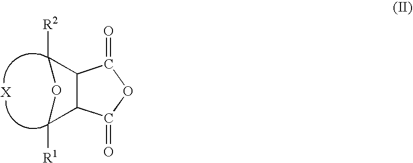

in which

X, R¹ and R² have the above mentioned meanings, with

α) compounds of the formula

HO—R⁵ (III)

in which

R⁵ has the above-mentioned meanings,

if appropriate in the presence of a diluent and if appropriate in the presence of a catalyst, or

β) with compounds of the formula

HS—R⁶ (IV)

in which

R⁶ has the above-mentioned meanings,

if appropriate in the presence of a diluent and if appropriate in the presence of a catalyst, or

γ) with compounds of the formula

H₂N—R⁷ (V)

in which

R⁷ has the above-mentioned meanings,

if appropriate in the presence of a diluent, or

δ) with compounds of the formula

H₂N—NH—R¹¹ (VI)

in which

R¹¹ has the above-mentioned meanings,

if appropriate in the presence of a diluent, or

ε) with compounds of the formula

H₂N—R¹² (VII)

in which

R¹² has the above-mentioned meanings,

if appropriate in the presence of a diluent, or

b) reacting 7-oxabicyclo[2.2.1]heptane derivatives of the formula

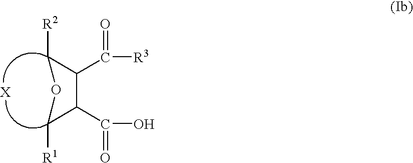

in which

X, R¹, R² and R³ have the above-mentioned meanings,

in a first step with ethyl chloroformate of the formula

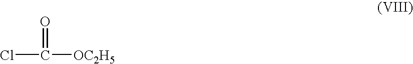

in the presence of a diluent and in the presence of an acid binder,

and reacting in a second step the resulting compounds of the formula

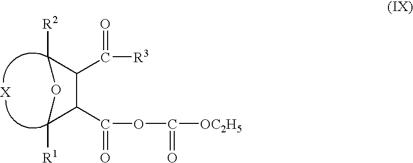

in which

X, R¹, R² and R³ have the above-mentioned meanings,

with compounds of the formula

H—R¹⁴ (X)

in which

R¹⁴ has the above-mentioned meanings,

in the presence of a diluent and if appropriate in the presence of an acid binder.

The already-known 7-oxabicyclo[2.2.1]heptane derivatives of the formula (I) can be prepared in the same manner.

Formula (Ia) provides a general definition of the new 7-oxabicyclo[2.2.1]heptane derivatives. Preferred are the compounds of the formula (Ia), in which

X, R¹, R² and R³ have the meanings, which have already been mentioned as preferred for these radicals, and

R¹⁴ represents a group selected from —SR⁹ and —NH—R¹⁰,

wherein

R⁹ and R¹⁰ have the meanings, which have already been mentioned as particularly preferred for these radicals.

Particularly preferred are the compounds of the formula (Ia), in which

X, R¹, R² and R³ have the meanings which have already been mentioned as particularly preferred for these radicals, and

R¹⁴ represents a group selected from —SR⁹ and —NH—R¹⁰,

wherein

R⁹ and R¹⁰ have the meanings, which have already been mentioned as very particularly preferred for these radicals.

Very particularly preferred are the compounds of the formula (Ia), in which

X, R¹, R² and R³ have the meanings which have already been mentioned as very particularly preferred for these radicals, and

R¹⁴ represents a group selected from —SR⁹ and —NH—R¹⁰,

wherein

R⁹ and R¹⁰ have the meanings which have already been mentioned as very particularly preferred for these radicals.

If 7-oxabicyclo[2.2.1]hept-5-ene-2,3-dicarboxylic acid anhydride and n-butanol are used as starting materials and sulphuric acid is used as a catalyst, the course of the reaction of process (a, variant α) according to the invention can be illustrated by the following formula scheme.

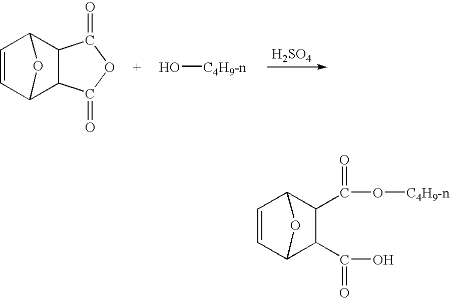

If 7-oxabicyclo[2.2.1]heptane-2,3-dicarboxylic acid anhydride and ethylmercaptane are used as starting materials and sulphuric acid is used as a catalyst, the course of the reaction of process (a, variant β) according to the invention can be illustrated by the following formula scheme.

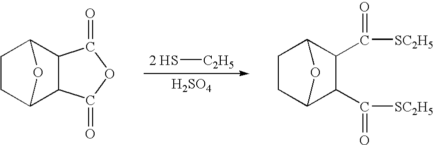

If 1,4-dimethyl-7-oxabicyclo[2.2.1]heptane-2,3-dicarboxylic acid anhydride and 3chloro-benzyl-amine are used as starting materials, the course of the reaction of process (a, variant γ) according to the invention can be illustrated by the following formula scheme.

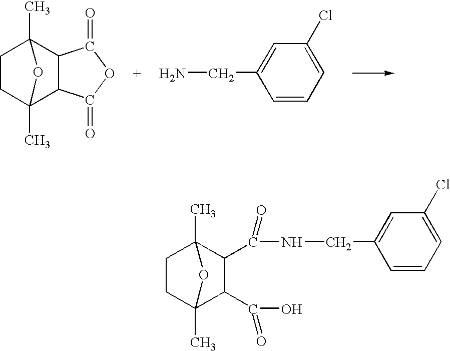

If 7-oxabicyclo[2.2.1]hept-5-ene-2,3-dicarboxylic acid anhydride and 2,4-dinitrophenyl hydrazine are used as starting materials, the course of the reaction of process (a, variant δ) according to the invention can be illustrated by the following formula scheme.

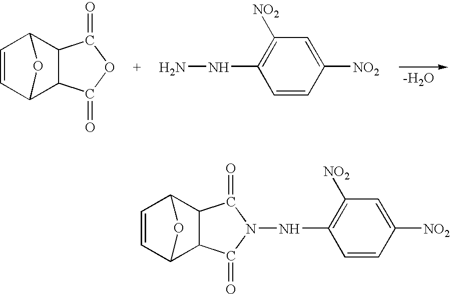

If 1,4-dimethyl-7-oxabicyclo[2,2,1]-heptane-2,3-dicarboxylic acid anhydride and 2phenyl-ethyl-amine are used as starting materials in the presence of a dehydrating agent, the course of the reaction of process (a, variant ε) according to the invention can be illustrated by the following formula scheme.

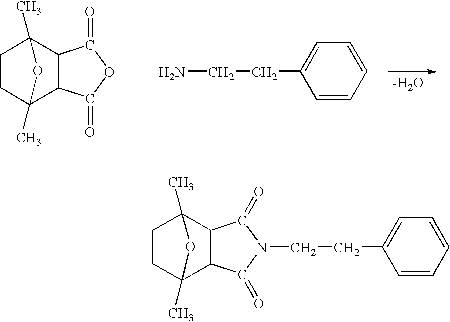

If 7-oxabicyclo[2.2.1]hept-5-ene-2-carboxylic acid (4-methoxy-anilide) 3-carboxylic acid is used as starting material and ethyl chloroformate as well as 4-methoxy-aniline are used as reaction components, the course of the reaction of process (b) according to the invention can be illustrated by the following formula scheme.

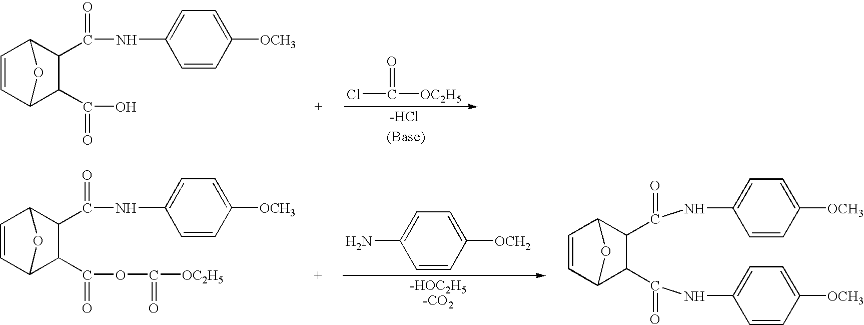

Formula (II) to (X) provide general definitions of the compounds, which are required as starting materials and as reaction components for carrying out the process according to the invention. In these formulae, the radicals X, R¹, R², R³, R⁴, R⁵, R⁶, R⁷, R¹¹, R¹² and R¹⁴ have the meanings, which have already been mentioned as preferred for these radicals.

The compounds of the formulae (II) to (X) are already known or can be prepared by known methods.

Process (a), variants (α) and (β) according to the invention can be carried out in the presence of a diluent.

Suitable diluents are all customary inert organic solvents. Preference is given to nitrites, such as acetonitrile, propionitrile, n- or i-butyronitrile or benzonitrile.

Suitable catalysts for carrying out process (a), variants (α) and (β) according to the invention are all agents, which are customarily used for carrying out reactions of this type. Preference is given to using inorganic acids, such as sulphuric acid.

The process (a), variants (αto ε), and (b) according to the invention are preferably carried out under atmospheric pressure.

When carrying out process (a), variants (α) and (β) according to the invention, the reaction temperatures can be varied within a relatively wide range. In general, the reaction is carried out at temperatures between 0° C. and 120° C., preferably between 20° C. and 100° C.

When carrying out process (a), variants (α) or (β) according to the invention, generally an equimolar amount or an excess of a compound of the formula (III) or (IV) is employed per mole of acid anhydride of the formula (II). Work-up is carried out by customary methods.

Process (a, variant γ) according to the invention can be carried out in the presence of a diluent. Suitable diluents are all customary inert organic solvents. Preference is given to nitrites, such as acetonitrile, propionitrile, n- or i-butyronitrile or benzonitrile. However, it is also possible to work in the presence of an additional compound of the formula (III) or (IV). Upon carrying out the reaction in this manner, it is possible to prepare compounds of the formula (I) comprising different radicals at the carbonyl groups.

When carrying out process (a, variants γ) according to the invention, the reaction temperatures can be varied within a relatively wide range. In general, the reaction is carried out at temperatures between 0° C. and 120° C., preferably between 20° C. and 100° C.

When carrying out process (a, variant γ) according to the invention, generally an equimolar amount or an excess of a compound of the formula (V) is employed per mole of acid anhydride of the formula (II). Work-up is carried out by customary methods.

Process (a, variants δ and ε) according to the invention can be carried out in the presence of a diluent. Suitable diluents are all customary inert organic solvents. Preference is given to using nitrites, such as acetonitrile, propionitrile, n- or i-butyronitrile or benzonitrile, and alcohols, such as methanol or ethanol.

When carrying out process (a, variants δ and ε) according to the invention, the reaction temperatures can be varied within a relatively wide range. In general, the reaction is carried out at temperatures between 0° C. and 120° C., preferably between 20° C. and 100° C.

When carrying out process (a, variants δ and ε) according to the invention, generally an equimolar amount or a slight excess of a compound of the formula (VI) or VII is employed per mole of acid anhydride of the formula (II). Work-up is carried out by customary methods.

The first step of process (b) according to the invention is preferably carried out in the presence of an acid binder. Suitable acid binders are all customary inorganic and organic bases. Preference is given to using alkaline earth metal or alkali metal hydrides, hydroxides, amides, alkoxides, acetates, carbonates or bicarbonates, such as, for example, sodium hydride, sodium amide, sodium methoxide, sodium ethoxide, potassium tert-butoxide, sodium hydroxide, potassium hydroxide, sodium acetate, potassium acetate, calcium acetate, sodium carbonate, potassium carbonate, potassium bicarbonate or sodium bicarbonate, further ammonium compounds, such as ammonium hydroxide, ammonium acetate or ammonium carbonate, and furthermore tertiary amines, such as trimethylamine, triethylamine, tributylamine, N,N-dimethylaniline, N,N-dimethylbenzylamine, pyridine, N-methylpiperidine, N-methylmorpholine, N,N-dimethylaminopyridine, diazabicyclooctane (DABCO), diazabicyclononene (DBN) or diazabicycloundecene (DBU).

The second step of process (b) according to the invention is preferably carried out without adding an additional acid binder.

Suitable diluents for carrying out steps one and two of process (b) according to the invention are all customary inert organic solvents. Preference is given to using nitrites, such as acetonitrile, propionitrile, n- or i-butyronitrile or benzonitrile.

When carrying out steps one and two of process (b) according to the invention, the reaction temperatures can be varied within a certain range. In each of the two steps, the reaction is generally carried out at temperatures between −10° C. and +20° C., preferably between −5° C. and +10° C.

When carrying out step one of process (b) according to the invention, generally an equimolar amount of ethyl chloroformate and an equivalent amount of an acid binder are employed per mole of 7-oxabicyclo[2.2.1]heptane derivative of the formula (Ib). Step two is then preferably carried out without prior isolation of the compound of the formula (IX) by adding an equivalent amount or an excess of a compound of the formula (X). However, it is also possible to isolate the compound of the formula (IX) first and then to add the compound of the formula (X). Work-up is, in each case, carried out by customary methods.

The compounds according to the invention have a potent microbicidal activity and can be employed for controlling undesirable microorganisms, such as fungi and bacteria, in crop protection and in the protection of materials. The compounds are suitable for the direct control of undesired microorganisms as well as for generating resistance in plants against attack by undesired microorganisms.

Fungicides are employed in crop protection for controlling Plasmodiophoromycetes, Oomycetes, Chytridiomycetes, Zygomycetes, Ascomycetes, Basidiomycetes and Deuteromycetes.

Bactericides are employed in crop protection for controlling Pseudomonadaceae, Rhizobiaceae, Enterobacteriaceae, Corynebacteriaceae and Streptomycetaceae.

Some pathogens causing fungal and bacterial diseases which come under the generic names listed above are mentioned as examples, but not by way of limitation:

Xanthomonas species, such as, for example, Xanthomonas campestris pv. oryzae;

Pseudomonas species, such as, for example Pseudomonas syringae pv. lachrymans;

Erwinia species, such as, for example, Erwinia amylovora;

Pythium species, such as, for example, Pythium ultimum;

Phytophthora species, such as, for example, Phytophthora infestans;

Pseudoperonospora species, such as, for example, i Pseudoperonospora humuli or Pseudoperonospora cubensis;

Plasmopara species, such as, for example, Plasmopara viticola;

Bremia species, such as, for example, Bremia lactucae;

Peronospora species, such as, for example, Peronospora pisi or P. brassicae;

Erysiphe species, such as, for example, Erysiphe graminis;

Sphaerotheca species, such as, for example, Sphaerotheca fuliginea;

Podosphaera species, such as, for example, Podosphaera leucotricha;

Venturia species, such as, for example, Venturia inaequalis;

Pyrenophora species, such as, for example, Pyrenophora teres or P. graminea (conidia form: Drechslera, Syn: Helminthosporium);

Cochliobolus species, such as, for example, Cochliobolus sativus (conidia form: Drechslera, Syn: Helminthosporium);

Uromyces species, such as, for examples Uromyces appendiculatus;

Puccinia species, such as, for example, Puccinia recondita;

Sclerotinia species, such as, for example, Sclerotinia sclerotiorun;

Tilletia species, such as for example, Tilletia caries;

Ustilago species, such as, for example, Ustilago nuda or Ustilago avenae;

Pellicilaria species, such as for example, Pellicularia sasakii;

Pyricularia species, such as for example, Pyricularia oryzae;

Fusarium species, such as, for example, Fusarium culmorum;

Botrytis species, such as, for example, Botrytis cinerea;

Septoria species, such as, for example, Septoria nodorurn;

Leptosphaeria species, such as, for example, Leptosphaeria nodorum;

Cercospora species, such as, for example, Cercospora canescens;

Altemaria species, such as, for example, Alternaria brassicae; and

Pseudocercosporella species, such as, for example, Pseudocercosporella herpotrichoides.

The good crop safety of the active compounds at the concentrations necessary for controlling plant diseases permits a treatment of above-ground parts of plants, and also a treatment of vegetative propagation stock and seed and of the soil.

The active compounds according to the invention can be used here particularly successfully for controlling cereal diseases, such as, for example, against Erysiphe species.

The active compounds according to the invention are also suitable for increasing the harvest yield. Additionally, they have reduced toxicity and good crop safety.

The active compounds according to the invention additionally have a strong resistance-inducing action in plants. They are therefore suitable for producing resistance in plants to attack by undesired microorganisms.

Resistance-inducing substances are understood in the present context as meaning those substances which on the one hand, when acting directly on the undesired microorganisms, only exhibit a low activity, but are able to stimulate the defense system of plants such that the treated plants, when subsequently inoculated with undesired microorganisms, display extensive resistance to these microorganisms.

Undesired microorganisms are to be understood in the present case as meaning phytophatogenic fungi, bacteriae and viruses. The substances according to the invention can thus be employed in order to produce resistance in plants within a certain period of time after treatment to attack by the harmful causative organisms mentioned. The period of time within which resistance is produced in general extends from 1 to 10 days, preferably 1 to 7 days, after the treatment of the plants with the active compounds.

In the protection of materials, the compounds according to the invention can be employed for protecting industrial materials against infection with, and destructoin by, undesired microorganisms.

Industrial materials in the present context are understood as meaning non-living materials which have been prepared for use in industry. For example, industrial materials which are intended to be protected by active compounds according to the invention from microbial change or destruction can be adhesives, sizes, paper and board, textiles, leather, wood, paints and plastic articles, cooling lubricants and other materials which can be infected with, or destroyed by, microorganisms. Parts of production plants, for example cooling-water circuits, which may be impaired by the proliferation of microorganisms may also be mentioned within the scope of the materials to be protected. Industrial materials which may be mentioned within the scope of the present invention are preferably adhesives, sizes, papers and boards, leather, wood, paints, cooling lubricants and heat-transfer liquids, particularly preferably wood.

Microorganisms capable of degrading or changing the industrial materials which may be mentioned are, for example, bacteria, fungi, yeast, algae and slime or organisms. The active compounds according to the invention preferably act against fungi, in particular moulds, wood-discolouring and wood-destroying fungi (Basidiomycetes) and against slime organisms and algae.

Microorganisms of the following genera may be mentioned as examples:

Alternaria, such as Alternaria tenuis,

Aspergillus, such as Aspergillus niger,

Chaetomium, such as Chaetomium globosum,

Coniophora, such as Coniephora puetana,

Lentinus, such as Lentinus tigrinus,

Penicillium, such as Penicillium glaucum,

Polyporus, such as Polyporus versicolor,

Aureobasidium, such as Aureobasidium pullulans,

Sclerophoma, such as Sclerophoma pityophila,

Trichoderma, such as Trichoderma viride,

Escherichia, such as Escherichia coli,

Pseudomonas, such as Pseudomonas aeruginosa,

Staphylococcus, such as Staphylococcus aureus,

The active compounds which can be used according to the invention are well tolerated by plants and have favourable homeotherm toxicity, and they can additionally be employed for controlling animal pests, in particular insects, arachnids and nematodes, which are encountered in agriculture, in forests, in horticulture, in the protection of stored products and of materials and also in the hygiene sector and in the veterinary field. The substances are active against normally sensitive and resistant species and also against pests in all or specific stages of development. The abovementioned animal pests include:

From the order of the Isopoda, for example, Oniscus asellus, Armadillidium vulgare and Porcellio scaber.

From the order of the Diplopoda, for example, Blaniulus guttulatus.

From the order of the Chilopoda, for example, Geophilus carpophagus and Scutigera spec.

From the order of the Symphyla, for example, Scutigerella immaculata.

From the order of the Thysanura, for example, Lepisma saccharina.

From the order of the Collembola, for example, Onychiurus armatus.

From the order of the Orthoptera, for example, Blatta orientalis, Periplaneta americana, Leucophaea maderae, Blattella germanica, Acheta domesticus, Gryllotalpa spp., Locusta migratoria migratorioides, Melanoplus differentialis and Schistocerca gregaria.

From the order of the Dermaptera, for example, Forficula auricularia.

From the order of the Isoptera, for example, Reticulitermes spp.

From the order of the Anoplura, for example, Pediculus humanus corporis,Haematopinus spp. and Linognathus spp.

From the order of the Mallophaga, for example, Trichodectes spp. and Damalinea spp.

From the order of the Thysanoptera, for example, Hercinothrips femoralis and Thrips tabaci.

From the order of the Heteroptera, for example, Eurygaster spp., Dysdercus intermedius, Piesma quadrata, Cimex lectularius, Rhodnius prolixus and Triatoma spp.

From the order of the Homoptera, for example, Aleurodes brassicae, Bernisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Euscelis bilobatus, Nephotettix cincticeps, Lecanium corni, Saissetia oleae, Laodelphax striatellus, Nilaparvata lugens, Aonidiella aurantii, Aspidiotus hederae, Pseudococcus spp. and Psylla spp.

From the order of the Lepidoptera, for example, Pectinophora gossypiella, Bupalus piniarius, Cheimatobia brumata, Lithocolletis blancardella, Hyponomeuta padella, Plutella maculipennis, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Spodoptera exigua, Mamestra brassicae, Panolis flammea, Spodoptera litura, Spodoptera spp., Trichoplusia ni, Carpocapsa pomonella, Pieris spp., Chilo spp., Pyrausta nubilalis, Ephestia kuehniella, Galleria mellonella, Tineola bisselliella, Tinea pellionella, Hofmannophila pseudospretella, Cacoecia podana, Capua reticulana, Choristoneura fumiferana, Clysia ambiguella, Homona magnanima and Tortrix viridana.

From the order of the Coleoptera, for example, Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis and Costelytra zealandica.

From the order of the Hymenoptera, for example, Diprion spp., Hoplocampa spp., Lasius spp., Monomorium pharaonis and Vespa spp.

From the order of the Diptera, for example, Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae and Tipula paludosa.

From the order of the Siphonaptera, for example, Xenopsylla cheopis and Ceratophyllus spp.

From the order of the Arachnida, for example, Scorpio maurus and Latrodectus mactans.

From the order of the Acarina, for example, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp. and Tetranychus spp.

The phytoparasitic nematodes include Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp. and Trichodorus spp.

The substances which can be used according to the invention can be employed particularly successfully for controlling plant-damaging mites, such as against the greenhouse red spider mite (Tetranychus urticae), or for controlling plant-damaging insects, such as against the green rice leaf hopper (Nephotettix cincticeps).

In some cases, the compounds according to the invention do also show a herbidical activity.

Depending on their particular physical and/or chemical properties, the active compounds can be converted to the customary formulations, such as solutions, emulsions, suspensions, powders, foams, pastes, granules, aerosols and mircroencapsulations in polymeric substances and in coating compositions for seeds, and ULV cool and warm fogging formulations.

These formulations are produced in a known manner, for example by mixing the active compounds with extenders, that is, liquid solvents, liquefied gases under pressure, and/or solid carriers, optionally with the use of surfactants, that is emulsifiers and/or dispersants, and/or foam formers. If the extender used is water, it is also possible to use, for example, organic solvents as auxiliary solvents. Suitable liquid solvents are essentially: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, alcohols such as butanol or glycol and their ethers and esters, ketones such as acetone, methyl ethyl ketone, methyl isobutyl ketone or cyclohexanone, strongly polar solvents such as dimethylformanide or dimethyl sulphoxide, or else water. Liquefied gaseous extenders or carriers are to be understood as meaning liquids which are gaseous at standard temperature and under atmospheric pressure, for example aerosol propellants such as halogenated hydrocarbons, or else butane, propane, nitrogen and carbon dioxide. Suitable solid carriers are: for example ground natural minerals such as kaolins, clays, talc, chalk, quartz, attapulgite, montmorillonite or diatomaceous earth, and ground synthetic minerals such as highly disperse silica, alumina and silicates. Suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, maize cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates. Suitable dispersants are: for example lignin-sulphite waste liquors and methylcellulose.

Tackifiers such as carboxymethylcellulose and natural and synthetic polymers in the form of powders, granules or latices, such as gum arabic, polyvinyl alcohol and polyvinyl acetate, or else natural phospholipids, such as cephalins and lecithins and synthetic phospholipids, can be used in the formulations. Other possible additives are mineral and vegetable oils.

It is possible to use colorants such as inorganic pigments, for example iron oxide, titanium oxide and Prussian Blue, and organic dyestuffs such as alizarin dyestuffs, azo dyestuffs and metal phthalocyanine dyestuffs, and trace nutrients such as salts of iron, manganese, boron, copper, cobalt, molybdenum and zinc.

The formulations generally comprise between 0.1 and 95 per cent by weight of active compound, preferably between 0.5 and 90%.

The active compounds according to the invention can be used as such or in their formulations also mixed with known fungicides, bactericides, acaricides, nematicides or insecticides in order thus, for example, to widen the spectrum of action or to prevent development of resistance. In many cases, synergistic effects are achieved, i.e. the activity of the mixture exceeds the activity of the individual components. Examples of co-components in mixtures are the following compounds:

Fungicides:

aldimorph, ampropylfos, ampropylfos potassium, andoprim, anilazine, azaconazole, azoxystrobin,

benalaxyl, benodanil, benomyl, benzamacril, benzamacril-isobutyl, bialaphos, binapacryl, biphenyl, bitertanol, blasticidin-S, bromuconazole, bupirimate, buthiobate,

calcium polysulphide, capsimycin, captafol, captan, carbendazim, carboxin, carvon, quinomethionate, chlobenthiazone, chlorfenazole, chloroneb, chloropicrin, chlorothalonil, chlozolinate, clozylacon, cufraneb, cymoxanil, cyproconazole, cyprodinil, cyprofuram, carpropamide,

debacarb, dichlorophen, diclobutrazole, diclofluanid, diclomezine, dicloran, diethofencarb, difenoconazole, dimethirimol, dimethomorph, diniconazole, diniconazole-M, dinocap, diphenylamine, dipyrithione, ditalimfos, dithianon, dodemorph, dodine, drazoxolon,

edifenphos, epoxiconazole, etaconazole, ethirimol, etridiazole,

famoxadon, fenapanil, fenarimol, fenbuconazole, fenfuram, fenitropan, fenpiclonil, fenpropidin, fenpropimorph, fentin acetate, fentin hydroxide, ferbam, ferimzone, fluazinam, flumetover, fluoromide, fluquinconazole, flurprimidol, flusilazole, flusulfamide, flutolanil, flutriafol, folpet, fosetyl-aluminium, fosetyl-sodium, fthalide, fuberidazole, furalaxyl, furametpyr, furcarbonil, furconazole, furconazole-cis, firmecyclox, fenhexamide,

guazatine,

hexachlorobenzene, hexaconazole, hymexazole,

imazalil, imibenconazole, iminoctadine, iminoctadine albesilate, iminoctadine triacetate, iodocarb, ipconazole, iprobenfos (IBP), iprodione, irumamycin, isoprothiolane, isovaledione, iprovalicarb,

kasugamycin, kresoxim-methyl, copper preparations, such as: copper hydroxide, copper naphthenate, copper oxychloride, copper sulphate, copper oxide, oxine-copper and Bordeaux mixture,

mancopper, mancozeb, maneb, meferimzone, mepanipyrim, mepronil, metalaxyl, metconazole, methasulfocarb, methfuroxam, metiram, metomeclam, metsulfovax, mildiomycin, myclobutanil, myclozolin,

nickel dimethyldithiocarbaniate, nitrothal-isopropyl, nuarimol,

ofurace, oxadixyl, oxamocarb, oxolinic acid, oxycarboxim, oxyfenthiin,

paclobutrazole, pefurazoate, penconazole, pencycuron, phosdiphen, pimaricin, piperalin, polyoxin, polyoxorim, probenazole, prochloraz, procyrnidone, propamocarb, propanosine-sodium, propiconazole, propineb, pyrazophos, pyrifenox, pyrimethanil, pyroquilon, pyroxyfur,

quinconazole, quintozene (PCNB), quinoxyfen

sulphur and sulphur preparations, spiroxamine,

tebuconazole, tecloftalam, tecnazene, tetcyclasis, tetraconazole, thiabendazole, thicyofen, thifluzamide, thiophanate-methyl, thiram, tioxymid, tolclofos-methyl, tolylfluanid, triadimefon, triadimenol, triazbutil, triazoxide, trichlamide, tricyclazole, tridemorph, triflumizole, triforine, triticonazole, trifloxystrobin,

uniconazole,

validamycin A, vinclozolin, viniconazole,

zarilamide, zineb, ziram and also

Dagger G,

OK-8705,

OK-8801,

α-(1,1-dimethylethyl)-β-(2-phenoxyethyl)-1H-1,2,4-triazole-1-ethanol,

α-(2,4-dichlorophenyl)-β-fluoro-β-propyl-1H-1,2,4-triazole-1-ethanol,

α-(2,4-dichlorophenyl)-β-methoxy-α-methyl-1H-1,2,4-triazole-1-ethanol,

α-(5-methyl-1,3-dioxan-5-yl)-β-[[4-(trifluoromethyl)-phenyl]-methylene]-1H-1,2,4-triazole-1-ethanol,

(5RS,6RS)-6-hydroxy-2,2,7,7-tetramethyl-5-(1H-1,2,4-triazol-1-yl)-3-octanone,

(E)-α-(methoxyimino)-N-methyl-2-phenoxy-phenylacetamide,

1-(2,4-dichlorophenyl)-2-(1H-1,2,4-triazol-1-yl)-ethanone-O-(phenylmethyl)-oxime,

1-(2-methyl-1 -naphthalenyl)-1H-pyrrole-2,5-dione,

1-(3,5-dichlorophenyl)-3-(2-propenyl)-2,5-pyrrolidinedione,

1-[(diiodomethyl)-sulphonyl]-4-methyl-benzene,

1-[[2-(2,4-dichlorophenyl)-1,3-dioxolan-2-yl]-methyl]-1H-imidazole,

1-[[2-(4-chlorophenyl)-3-phenyloxiranyl]-methyl]-1H-1,2,4-triazole,

1-[1-[2-[(2,4-dichlorophenyl)-methoxy]-phenyl]-ethenyl]-1H-imidazole,

1-methyl-5-nonyl-2-(phenylmethyl)-3-pyrrolidinole,

2′,6′-dibromo-2-methyl-4-trifluoromethoxy-4′-trifluoro-methyl-1,3-thiazole-5-carboxanilide,

2,6-dichloro-5-(methylthio)-4-pyrimidinyl-thiocyanate,

2,6-dichloro-N-(4-trifluoromethylbenzyl)-benzamide,

2,6-dichloro-N-[[4-(trifluoromethyl)-phenyl]-methyl]-benzamide,

2-(2,3,3 -triiodo-2-propenyl)-2H-tetrazole,

2-[(1-methylethyl)-sulphonyl]-5-(trichloromethyl)-1,3,4-thiadiazole,

2-[[6-deoxy-4-O-(4-O-methyl-β-D-glycopyranosyl)-α-D-glucopyranosyl]-amino]-4-methoxy-1H-pyrrolo[2,3-d]pyrimidine-5-carbonitrile,

2-aminobutane,

2-bromo-2-(bromomethyl)-pentanedinitrile,

2-chloro-N-(2,3-dihydro-1,1,3-trimethyl-1H-inden-4-yl)-3-pyridinecarboxamide,

2-chloro-N-(2,6-dimethylphenyl)-N-(isotiocyanatomethyl)-acetamide,

2-phenylphenol (OPP),

3,4-dichloro-1-[4-(difluoromethoxy)-phenyl]-1H-pyrrole-2,5-dione,

3,5-dichloro-N-[cyano-[(1-methyl-2-propinyl)-oxy]-methyl]-benzamide,

3-(1,1-dimethylpropyl-1-oxo-1H-indene-2-carbonitrile,

3-[2-(4-chlorophenyl)-5-ethoxy-3-isoxazolidinyl]-pyridine,

4-chloro-2-cyano-N,N-dimethyl-5-(4-methylphenyl)-1H-imidazole-1-sulphonamide,

4-methyl-tetrazolo[1,5-a]quinazolin-5(4H)-one,

8-hydroxyquinoline sulphate,

9H-xanthene-2-[(phenylamino)-carbonyl]-9-carboxylic hydrazide,

bis-(1-methylethyl)-3-methyl-4-[(3-methylbenzoyl)-oxy]-2,5-thiophenedicarboxylate,

cis-1-(4-chlorophenyl)-2-(1H-1,2,4-triazol-1-yl)-cycloheptanol,

cis-4-[3-[4-(1,1-dimethylpropyl)-phenyl-2-methylpropyl]-2,6-dimethylmorpholinehydrochloride,

ethyl [(4-chlorophenyl)-azo]-cyanoacetate,

potassium hydrogen carbonate,

methanetetrathiol sodium salt,

methyl 1-(2,3-dihydro-2,2-dimethyl-1H-inden-1-yl)-1H-imidazole-5-carboxylate,

methyl N-(2,6-dimethylphenyl)-N-(5-isoxazolylcarbonyl)-DL-alaninate,

methyl N-(chloroacetyl)-N-(2,6-dimethylphenyl)-DL-alaninate,

N-(2,6-dimethylphenyl)-2-methoxy-N-(tetrahydro-2-oxo-3-furanyl)-acetamide,

N-(2,6-dimethylphenyl)-2-methoxy-N-(tetrahydro-2-oxo-3-thenyl)-acetamride,

N-(2-chloro-4-nitrophenyl)4methyl-3-nitro-benzenesulphonamide,

N-(4-cyclohexylphenyl)- 1,4,5,6-tetrahydro-2-pyrimidineamine,

N-(4-hexylphenyl)-1,4,5,6-tetrahydro-2-pyrimidineamine,

N-(5-chloro-2-methylphenyl)-2-methoxy-N-(2-oxo-3-oxazolidinyl)-acetamide,

N-(6-methoxy)-3-pyridinyl)-cyclopropanecarboxamide,

N-[2,2,2-trichloro-1-[(chloroacetyl)-amino]-ethyl]-benzamide,

N-[3-chloro4,5-bis-(2-propinyloxy)-phenyl]-N′-methoxy-methaneimidamide,

N-formyl-N-hydroxy-DL-alanine-sodium salt,

O,O-diethyl [2-(dipropylamino)-2-oxoethyl]-ethylphosphoramidothioate,

O-methyl S-phenyl phenylpropylphosphoramidothioate,

S-methyl 1,2,3-benzothiadiazole-7-carbothioate,

spiro[2H]-1-benzopyrane-2,1′(3′H)-isobenzofuran]-3′-one.

Bactericides:

bromopol, dichlorophen, nitrapyrin, nickel dimethyldithiocarbamate, kasugamycin, octhilinone, furancarboxylic acid, oxytetracyclin, probenazole, streptomycin, tecloftalam, copper sulphate and other copper preparations.

Insecticides/Acaricides/Nematicides:

abamectin, acephate, acrinathrin, alanycarb, aldicarb, alphamethrin, amitraz, avemiectin, AZ 60541, azadirachtin, azinphos A, azinphos M, azocyclotin,

Bacillus thuringiensis, 4-bromo-2-(4-chlorophenyl)-1-(ethoxymethyl)-5-(trifluoromethyl)-1H-pyrrole-3-carbonitrile benidiocarb, benfuracarb, bensultap, betacyfluthrin, bifenthrin, BPMC, brofenprox, bromophos A, bufencarb, buprofezin, butocarboxin, butylpyridaben,

cadusafos, carbaryl, carbofuran, carbophenothion, carbosulfan, cartap, chloethocarb, chlorethoxyfos, chlorfenapyr, chlorfenvinphos, chlorfluazuron, chlormephos, N-[(6-chloro-3-pyridinyl)-methyl]-N′-cyano-N-methyl-ethaneimidamide, chlorpyrifos, chlorpyrifos M, cis-resmethrin, clocythrin, clofentezine, cyanophos, cycloprothrin, cyfluthrin, cyhalothrin, cyhexatin, cypermethrin, cyromazine,

deltamethrin, demeton M, demeton S, demeton S-methyl, diafenthiuron, diazinon, dichlofenthion, dichlorvos, dicliphos, dicrotophos, diethion, diflubenzuron, dimethoate,

dimethylvinphos, dioxathion, disulfoton,

emamnectin, esfenvalerate, ethiofencarb, ethion, ethofenprox, ethoprophos, etrimphos,

fenamiphos, fenazaquin, fenbutatin oxide, fenitrothion, fenobucarb, fenothiocarb, fenoxycarb, fenpropathrin, fenpyrad, fenpyroximate, fenthion, fenvalerate, fipronil, fluazuron, flucycloxuron, flucythrinate, flufenoxuron, flufenprox, fluvalinate, fonophos, formothion, fosthiazate, fubfenprox, furathiocarb,

HCH, heptenophos, hexaflumuron, hexythiazox,

imidacloprid, isazophos, isofenphos, isoprocarb, isoxathion, ivermectin,

lambda-cyhalothrin, lufenuron,

malathion, mecarbam, mervinphos, mesulfenphos, metaldehyde, methacrifos, methamidophos, methidathion, methiocarb, methomyl, metolcarb, milbemectin, monocrotophos, moxidectin,

naled, NC 184, nitenpyram,

omethoate, oxamyl, oxydemethon M, oxydeprofos,

parathion A, parathion M, permethrin, phenthoate, phorate, phosalone, phosmet, phosphamidon, phoxim, pirimicarb, pirimiphos M, pirimiphos A, profenofos, promecarb, propaphos, propoxur, prothiofos, prothoate, pymetrozin, pyrachlophos, pyridaphenthion, pyresmethrin, pyrethirm, pyridaben, pyrimidifen, pyriproxifen,

quinalphos,

salithion, sebufos, silafluofen, sulfotep, sulprofos,

tebufenozide, tebufenpyrad, tebupimiphos, teflubenzuron, tefluthrin, temephos, terbam, terbufos, tetrachlorvinphos, thiafenox, thiamethoxam, thiodicarb, thiofanox, thiomethon, thionazin, thuringiensin, tralomethrin, triarathen, triazophos, triazuron, trichlorfon, triflumuron, trimethacarb, thiacloprid,

vamidothion, XMC, xylylcarb, zetamethrin.

It is also possible to admix other known active compounds, such as herbicides, or else fertilizers and growth-promoting-substances.

The active compounds can be used as such, in the form of their formulations or the use forms prepared therefrom, such as ready-to-use solutions, suspensions, wettable powders, pastes, soluble powders, dusts and granules. They are used in the customary manner, for example by pouring, spraying, atomizing, spreading, dusting, foaming, brushing on and the like. It is further possible to apply the active compounds by the ultra-low volume method or to inject the active compound formulation, or the active compound itself, into the soil. The seed of the plants can also be treated.

When using the active compounds according to the invention for controlling microorganisms, the application rates can be varied within a relatively wide range, depending on the kind of application. When treating parts of plants, the active compound application rates are generally between 0.1 and 10,000 g/ha, preferably between 10 and 1000 g/ha. When treating seed, the active compound application rates are generally between 0.001 and 50 g per kilogram of seed, preferably between 0.01 and 10 g per kilogram of seed. When treating the soil, the active compound application rates are generally between 0.1 and 10,000 g/ha, preferably between 1 and 5000 g/ha.

The compositions used for the protection of industrial materials generally comprise an amount of from 1 to 95%, preferably from 10 to 75%, of the active compounds.

The use concentrations of the active compounds according to the invention depend on the species and the occurrence of the microorganisms to be controlled and on the composition of the material to be protected. The optimal rate of application can be determined by test series. In general, the use concentrations are in the range from 0.001 to 5% by weight, preferably from 0.05 to 1.0% by weight, based on the material to be protected.

It is possible to increase the activity and the activity spectrum of the active compounds which are to be used according to the invention in the protection of materials, or of the compositions, concentrates or quite generally formulations which can be prepared from these, by adding, if appropriate, other compounds having antimicrobial action, fuigicides, bactericides, herbicides, insecticides or other active compounds for increasing the activity spectrum or for obtaining special effects such as, for example, additional protection against insects. These mixtures may have a wider activity spectrum than the compounds according to the invention.

When used against animal pests, too, the substances which can be used according to the invention, in commercially available formulations and also in the use forms prepared from these formulations, can be present as a mixture with synergists. Synergists are compounds which enhance the effectiveness of the active compounds, without it being necessary for the synergist which is added to be active itself.

The content of active compound in the use forms prepared from the commercially available formulations can vary within wide ranges. The concentration of active compound in the use forms can be from 0.0000001 to 95% by weight of active compound, preferably between 0.0001 and 1% by weight,

Application is carried out in a manner which is appropriate for the use forms.

The preparation and the use of the compounds according to the invention are illustrated by the examples which follow.

### PREPATATION EXAMPLES

### Examples 1

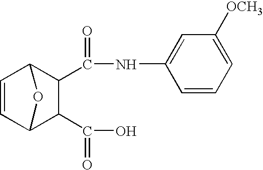

2.5 g (20 mmol) of 3-methoxy-aniline were added to a solution of 3.3 g (20 mmol) of 7-oxabicyclo[2.2.1]hept-5-ene-2,3-dicarboxylic acid anhydride in 25 ml of aceto-nitrile at a temperature of 35° C. The mixture was stirred for 2 hours at a temperature between 30 and 35° C. The solid precipitated was filtered off and washed two times with, in each case, 20 ml of acetone. 4 g (=69% of theory) of the compound of the formula shown above were obtained in the form of a white solid having a melting point of 158-160° C.

### Example 2

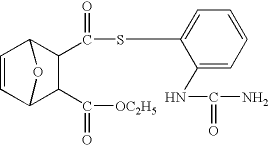

1.8 g (12 mmol) of 2-amino-benzothiazole were added to a solution of 1.7 g (10 mmol) of 7-oxabicyclo[2.2.1]hept-5-ene-2,3-dicarboxylic acid anhydride in 10 ml of absolute ethanol. The mixture was stirred for 3 hours at a temperature between 50 and 55° C. After cooling to room temperature, the solid precipitated was filtered off and washed two times with, in each case, 5 ml of absolute ethanol and once with 3 ml of hexane. 3.1 g (=90% of theory) of the compound of the formula shown above were obtained in the form of a white solid having a melting point of 149-151° C.

### Example 3

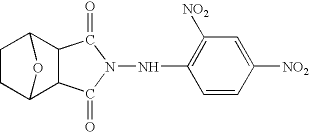

2.0 g (10 mmol) of 2,4-dinitro-phenyl-hydrazine were added to a solution of 1.7 g (10 mmol) of 7-oxabicyclo[2.2.1]hept-5-ene-2,3-dicarboxylic acid anhydride in 15 ml of abosolute ethanol. The mixture was stirred for 16 hours at a temperature between 60 and 65° C. After cooling to room temperature, the solid precipitated was filtered off and washed with 30 ml of ethyl acetate. The resulting product was purified by recrystallization. 0.6 g (=18% of theory) of the compound of the formula shown above were obtained in the form of a yellow solid having a melting point of 165-166° C.

### Example 4

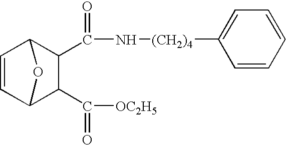

3.0 g (20 mmol) of 4-phenyl-butyl-amine were added to a solution of 3.3 g (20 mmol) of 7-oxabicyclo[2.2.1]hept-5-ene-2,3-dicarboxylic acid anhydride in 25 ml of acetonitrile at a temperature of 35° C. The mixtute was stirred for two hours at a temperature between 30 and 35° C. The solid precipitated was filtered off and washed twice with, in cach case, 20 ml of acetone 4 g (=63% of theory) of the compound of the formula shown above were obtained in the form of a white solid having a melting point of 124-126° C.

### Example 5

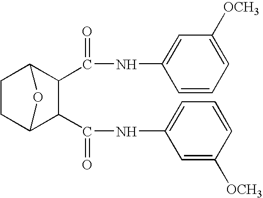

0.527 g (5.22 mmol) of ethyl chloroformate were added to a suspension of 1.52 g (5.22 mmol) of 7-oxabicyclo[2.2.1]-heptane-1-carboxylic acid(3-methoxy-anilide)2-carboxylic acid and 0.527 g (0.52 mmol) of tri-ethyl-amine in 20 ml of acetonitrile whilst stirring at a temperature between 0 and 5° C. The reaction mixture was stirred for 20 minutes at a temperature between 0 and 5° C. 0.64 g of 3-methoxy-aniline were then added, and the resulting mixture was then stirred for 2 hours at room temperature. The solid precipitated was filtered off and washed with acetone. 1.32 g (=63.8% of theory) of the compound of the formula shown above were obtained in the form of a white solid having a melting point of 227-229° C.

### Example 6

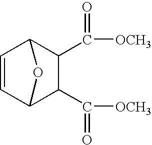

2 drops of concentrated sulphuric acid were added to a solution of 1.66 g (10 mmol) of 7-oxabicyclo[2.2.1]hept-5-ene-2,3-dicarboxylic acid anhydride in 20 ml of methanol. The reaction mixture was refluxed for 2 hours. After cooling to room temperature, the resulting crystals were filtered off. 0.89 g (=42% of theory) of the compound of the formula shown above were obtained in the form of a white solid having a melting point of 120.1-121.1° C.

The compounds shown in the following Table 1 were also prepared by the above-mentioned methods.

TABLE 1

| | |
|---|---|
| | (I) |
| 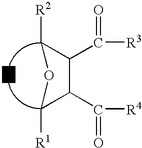 | |

| Example | | | | | | |
|---|---|---|---|---|---|---|
| No | X | R¹ | R² | R³ | R⁴ | |
| | | | | | | Physical |
| | | | | | | Constant |
| 7 | —CH═CH— | H | H | 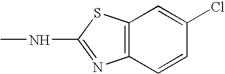 | —OH | M.p. 191° C. |
| 8 | —CH═CH— | H | H | 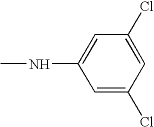 | —OH | M.p. 190-192° C. |
| 9 | —CH═CH— | H | H | 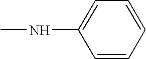 | —OH | M.p. 198° C. |
| 10 | —CH═CH— | H | H | 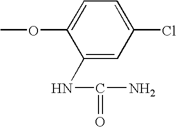 | —OC₂H₅ | M.p. 120° C. |
| 11 | —CH═CH— | H | H | 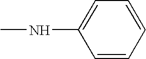 | —OH | M.p. 154° C. |
| 12 | —CH═CH— | H | H | —OH | —OH | M.p. |
| 13 | —CH═CH— | H | H | 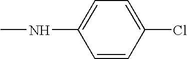 | —OH | M.p. 194° C. |
| 14 | —CH═CH— | H | H | 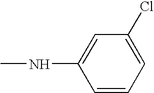 | —OH | M.p. 196° C. |
| 15 | —CH═CH— | H | H | 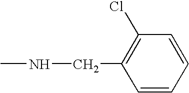 | —OH | M.p. 140° C. |
| 16 | —CH═CH— | H | H | 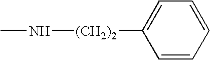 | —OH | M.p. 130° C. |
| 17 | —CH═CH— | H | H | 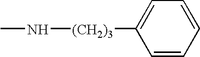 | —OH | M.p. 138° C. |
| 18 | —CH═CH— | H | H | 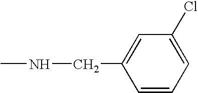 | —OH | M.p. 138° C. |
| 19 | —CH═CH— | H | H | 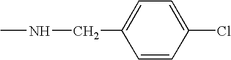 | —OH | M.p. 150° C. |
| 20 | —CH═CH— | H | H | 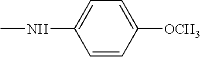 | —OH | M.p. 188° C. |
| 21 | —CH═CH— | H | H | 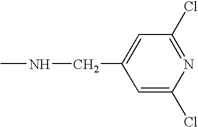 | —OH | M.p. 144° C. |
| 22 | —CH═CH— | H | H | 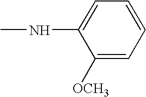 | —OH | M.p. 140° C. |
| 23 | —CH═CH— | H | H | 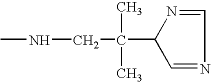 | —OH | M.p. 140° C. |
| 24 | —CH═CH— | H | H | 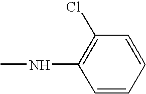 | —OH | M.p. 121° C. |
| 25 | —CH═CH— | H | CH₃ | 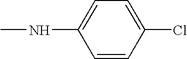 | —OH | M.p. 196° C. |
| 26 | —CH═CH— | H | H | 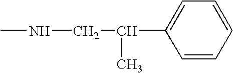 | —OH | M.p. 118° C. |
| 27 | —CH═CH— | H | H | —NH—C₄H₉—n | —OH | M.p. 116° C. |
| 28 | —CH═CH— | H | CH₃ | 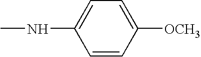 | —OH | M.p. 189° C. |
| 29 | —CH═CH— | H | CH₃ | 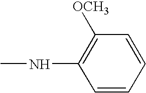 | —OH | M.p. 140° C. |
| 30 | —CH═CH— | H | H | 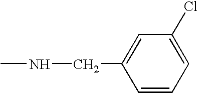 | —OH | M.p. 154° C. |
| 31 | —CH═CH— | H | H | 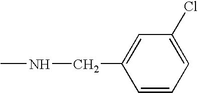 | 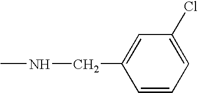 | M.p. 164° C. |
| 32 | —CH₂—CH₂— | H | H | 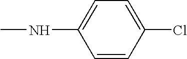 | —OH | M.p. 164° C. |
| 33 | —CH₂—CH₂— | H | H | 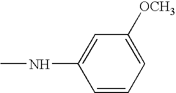 | —OH | M.p. 162° C. |
| 34 | —CH₂—CH₂— | H | H | 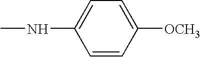 | —OH | M.p. 188° C. |
| 35 | —CH₂—CH₂— | H | H | 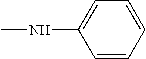 | —OH | M.p. 173° C. |
| 36 | —CH₂—CH₂— | H | H | 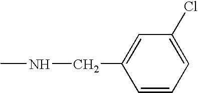 | 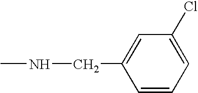 | M.p. 185° C. |
| 37 | —CH₂—CH₂— | H | H | 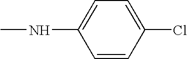 | 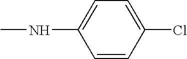 | M.p. 278° C. |
| 38 | —CH₂—CH₂— | H | H | 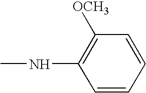 | —OH | M.p. 148° C. |
| 39 | —CH₂—CH₂— | H | H | 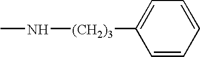 | —OH | M.p. 136° C. |
| 40 | —CH₂—CH₂— | H | H | 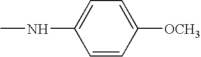 | 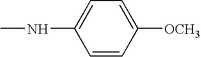 | M.p. 255° C. |
| 41 | —CH₂—CH₂— | H | H | 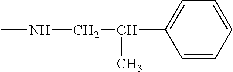 | —OH | M.p. 115° C. |
| 42 | —CH₂—CH₂— | H | H | 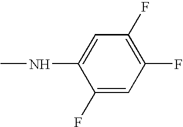 | —OH | M.p. 171° C. |
| 43 | —CH₂—CH₂— | H | H | 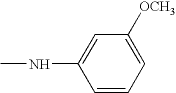 | 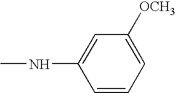 | M.p. 193° C. |
| 44 | —CH₂—CH₂— | H | H | 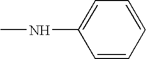 | 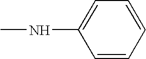 | M.p. 268° C. |
| 45 | —CH₂—CH₂— | H | H | 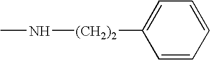 | —OH | M.p. 144° C. |
| 46 | —CH₂—CH₂— | H | H | 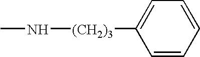 | 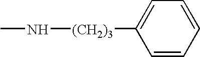 | M.p. 182° C. |
| 47 | —CH—CH— | H | H | 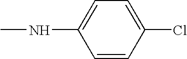 | —NH—C₄H₉—n | M.p. 174° C. |
| 48 | —CH═CH— | H | H | —NH—C₄H₉—n | —NH—C₄H₉—n | M.p. 173° C. |
| 49 | —CH═CH— | H | H | 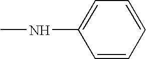 | 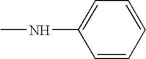 | M.p. 178° C. |
| 50 | —CH═CH— | H | H | 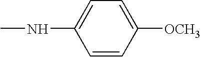 | 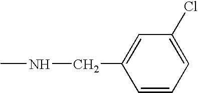 | M.p. 173° C. |
| 51 | —CH₂—CH₂— | H | H | 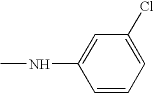 | 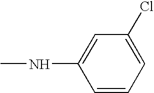 | M.p. 198° C. |
| 52 | —CH₂—CH₂— | CH₃ | CH₃ | 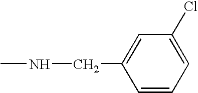 | —OH | M.p. 161° C. |
| 53 | —CH═CH— | H | H | 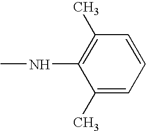 | —OH | |
| 54 | —CH₂—CH₂— | CH₃ | CH₃ | 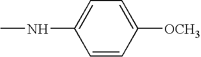 | —OH | M.p. 151° C. |
| 55 | —CH₂—CH₂— | H | H | —OH | —OH | |
| | | | | | | Physical |
| | | | | | | Constant |
| | | | | | | (M.p.) |
| 56 | —CH₂—CH₂— | H | H | 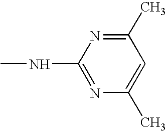 | —OH | |
| 57 | —CH₂—CH₂— | H | H | —OCH₃ | —OCH₃ | |
| 58 | —CH═CH— | H | H | 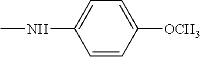 | 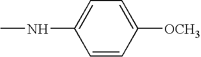 | 177° C. |
| 59 | —CH₂—CH₂— | CH₃ | CH₃ | 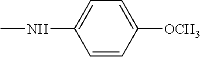 | —OH | 150° C. |
| 60 | —CH═CH— | H | H | —OH | —OH | 138° C. |
| 61 | —CH₂—CH₂— | H | H | 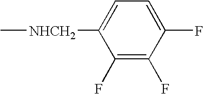 | —OH | 162° C. |
| 62 | —CH═CH₁₃ | H | H | 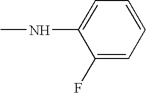 | —OH | 146° C. |
| 63 | —CH₂—CH₂— | CH₃ | H | 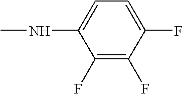 | —OH | 142° C. |
| 64 | —CH₂—CH₂— | CH₃ | H | 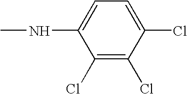 | —OH | 176° C. |
| 65 | —CH₂—CH₂— | CH₃ | H | 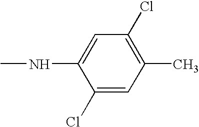 | —OH | 124° C. |
| 66 | —CH₂—CH₂— | CH₃ | H | 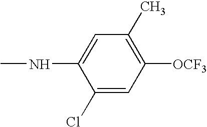 | —OH | 178° C. |
| 67 | —CH₂—CH₂— | CH₃ | H | 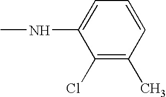 | —OH | 191° C. |
| 68 | —CH₂—CH₂— | CH₃ | H | 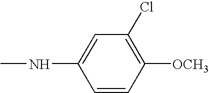 | —OH | 179° C. |
| 69 | —CH₂—CH₂— | CH₃ | H | 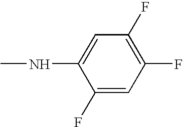 | —OH | 146° C. |
| 70 | —CH₂—CH₂— | CH₃ | H | 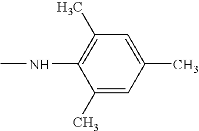 | —OH | 168° C. |
| 71 | —CH₂—CH₂— | H | H | 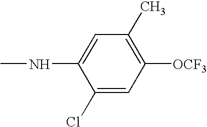 | —OH | 204° C. |
| 72 | —CH₂—CH₂— | CH₃ | H | 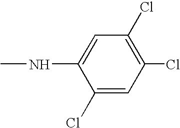 | —OH | 157° C. |
| 73 | —CH₂—CH₂— | CH₃ | H | 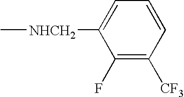 | —OH | 162° C. |
| 74 | —CH₂—CH₂— | H | H | 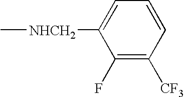 | —OH | 148° C. |
| 75 | —CH₂—CH₂— | CH₃ | H | 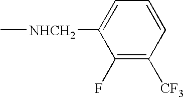 | —OH | 158° C. |
| 76 | —CH₂—CH₂— | CH₃ | CH₃ | 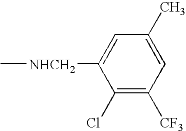 | —OH | 190° C. |
| 77 | —CH₂—CH₂— | H | H | 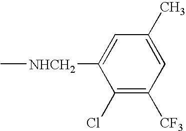 | —OH | 188° C. |
| 78 | —CH₂—CH₂— | CH₃ | H | 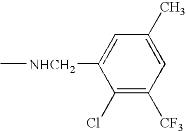 | —OH | 157° C. |
| 79 | —CH₂—CH₂— | CH₃ | H | 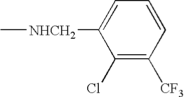 | —OH | 181° C. |
| 80 | —CH₂—CH₂— | CH₃ | H | 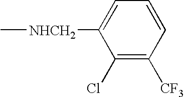 | —OH | 168° C. |
| 81 | —CH₂—CH₂— | H | H | 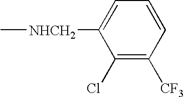 | —OH | 171° C. |
| 82 | —CH₂—CH₂— | H | H | 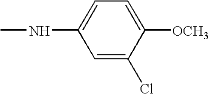 | —OH | 232° C. |
| 83 | —CH₂—CH₂— | H | H | 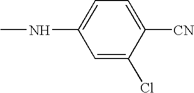 | —OH | 163° C. |
| 84 | —CH₂—CH₂— | H | H | 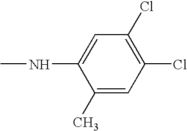 | —OH | 198° C. |
| 85 | —CH₂—CH₂— | H | H | 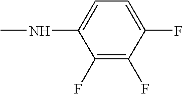 | —OH | 143° C. |
| 86 | —CH₂—CH₂— | H | H | 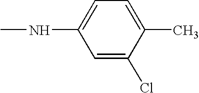 | —OH | 185° C. |
| 87 | —CH₂—CH₂— | H | H | 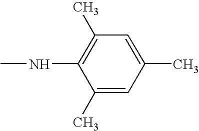 | —OH | 184° C. |
| 88 | —CH₂—CH₂— | H | H | 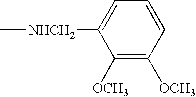 | —OH | 165° C. |
| 89 | —CH₂—CH₂— | CH₃ | H | 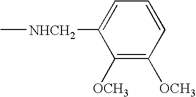 | —OH | 142° C. |
| 90 | —CH₂—CH₂— | CH₃ | CH₃ | 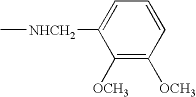 | —OH | 150° C. |
| 91 | —CH₂—CH₂— | CH₃ | H | 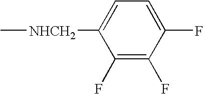 | —OH | 141° C. |
| 92 | —CH₂—CH₂— | CH₃ | CH₃ | 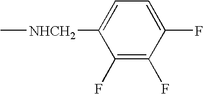 | —OH | 169° C. |
| 93 | —CH═CH— | H | H | 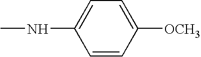 | —NH—CH(CH₃)₂ | 189° C. |
| 94 | —CH₂—CH₂— | H | H | 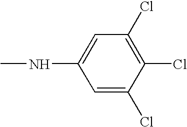 | —OH | 163° C. |
| 95 | —CH₂—CH₂— | H | CH₃ | 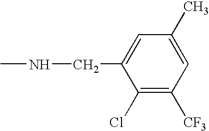 | —OH | 157° C. |
| 96 | —CH₂—CH₂— | —CH₃ | —CH₃ | 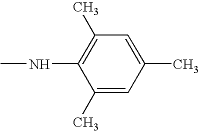 | —OH | 154° C. |
| 97 | —CH₂—CH₂— | —CH₃ | —CH₃ | 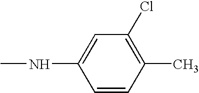 | —OH | 142° C. |
| 98 | —CH₂—CH₂— | H | H | 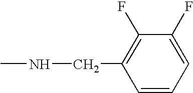 | —OH | 137° C. |
| 99 | —CH₂—CH₂— | H | —CH₃ | 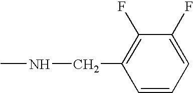 | —OH | 148° C. |
| 100 | —CH₂—CH₂— | —CH₃ | —CH₃ | 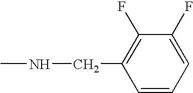 | —OH | 142° C. |
| 101 | —CH₂—CH₂— | H | H | —NH—(CH₂)₂—O—(CH₂)₃—CF₂—CF₃ | —OH | 109° C. |
| 102 | —CH₂—CH₂— | H | H | —NH—(CH₂)₂—O—(CH₂)₃—CF₂—CF₃ | —OH | log p = 2.69 |
| 103 | —CH═CH— | H | H | —NH—(CH₂)₂—O—(CH₂)₃—CF₂—CF₃ | —OH | log p = 2.16 |
| 104 | —CH═CH— | H | H | —NH—(CH₂—CH₂—O)₂—(CH₂)₃—CF₂—CF₃ | —OH | log p = 2.22 |
| 105 | —CH₂—CH₂— | —CH₃ | CH₃ | 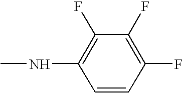 | —OH | 149° C. |
| 106 | —CH₂—CH₂— | —CH₃ | H | 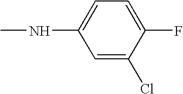 | —OH | 171° C. |
| 107 | —CH₂—CH₂— | —CH₃ | —CH₃ | 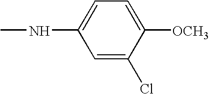 | —OH | 220° C. |
| 108 | —CH₂—CH₂— | H | H | 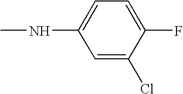 | 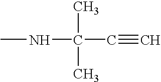 | 176° C. |
| 109 | —CH₂—CH₂— | —CH₃ | —CH₃ | 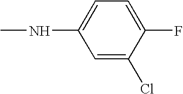 | —NH—CH(CH₃)₂ | 172° C. |
| 110 | —CH₂—CH₂— | H | H | 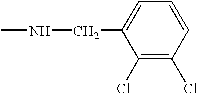 | —OH | 156° C. |
| 111 | —CH₂—CH₂— | —CH₃ | H | 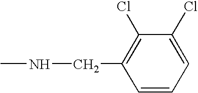 | —OH | 164° C. |
| 112 | —CH₂—CH₂— | —CH₃ | —CH₃ | 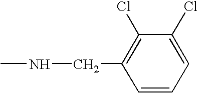 | —OH | 143° C. |
| 113 | —CH₂—CH₂— | H | H | 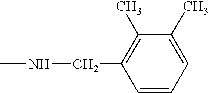 | —OH | 160° C. |
| 114 | —CH₂—CH₂— | H | H | 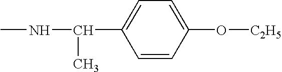 | —OH | 155° C. |
| 115 | —CH₂—CH₂— | —CH₃ | H | 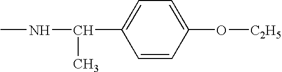 | —OH | 163° C. |
| 116 | —CH₂—CH₂— | —CH₃ | H | 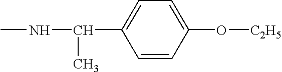 | —OH | 141° C. |
| 117 | —CH₂—CH₂— | H | H | 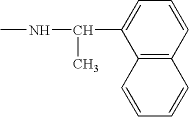 | —OH | 162° C. |
| 118 | —CH₂—CH₂— | —CH₃ | H | 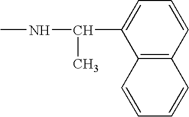 | 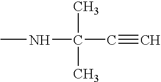 | 170° C. |
| 119 | —CH₂—CH₂— | —CH₃ | —CH₃ | 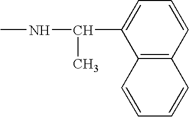 | —OH | 152° C. |
| 120 | —CH₂—CH₂— | H | H | 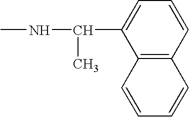 | —OH | 162° C. |
| 121 | —CH₂—CH₂— | —CH₃ | H | 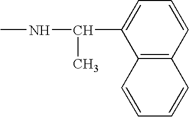 | —OH | 169° C. |
| 122 | —CH₂—CH₂— | H | H | 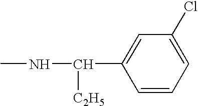 | —OH | 173° C. |
| 123 | —CH₂—CH₂— | H | H | 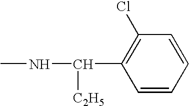 | —OH | 159° C. |
| 124 | —CH₂—CH₂— | —CH₃ | H | 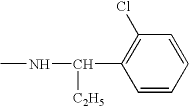 | —OH | 180° C. |
| 125 | —CH₂—CH₂— | H | H | 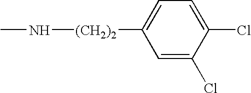 | —OH | 164° C. |
| 126 | —CH₂—CH₂— | —CH₃ | H | 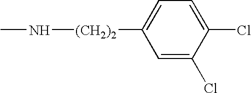 | —OH | 254° C. |
| 127 | —CH₂—CH₂— | H | H | 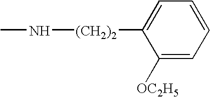 | —OH | 138° C. |
| 128 | —CH₂—CH₂— | —CH₃ | H | 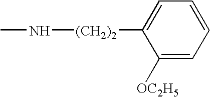 | 120° C. | |
| 129 | —CH₂—CH₂— | —CH₃ | —CH₃ | 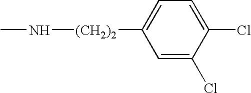 | —OH | 137° C. |
| 130 | —CH₂—CH₂— | H | H | 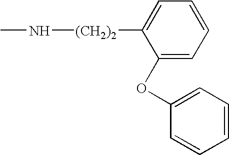 | —OH | 156° C. |
| 131 | —CH₂—CH₂— | —CH₃ | H | 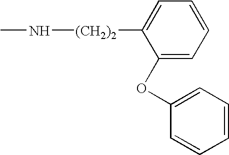 | —OH | 139° C. |
| 132 | —CH₂—CH₂— | —CH₃ | —CH₃ | 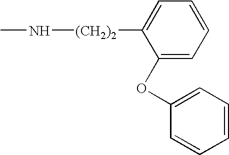 | —OH | 124° C. |
| 133 | —CH₂—CH₂— | H | H | 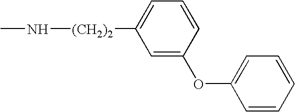 | —OH | 140° C. |
| 134 | —CH₂—CH₂— | —CH₃ | H | 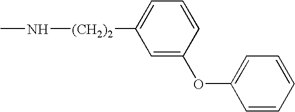 | —OH | 129° C. |
| 135 | —CH₂—CH₂— | H | H | 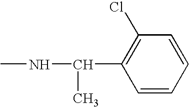 | —OH | 173° C. |
| 136 | —CH₂—CH₂— | —CH₃ | H | 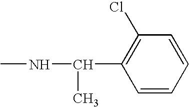 | —OH | 180° C. |
| 137 | —CH₂—CH₂— | —CH₃ | —CH₃ | 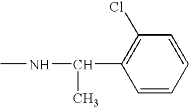 | —OH | 150° C. |
| 138 | —CH₂—CH₂— | H | H | 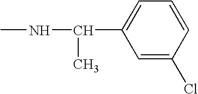 | —OH | 158° C. |
| 139 | —CH₂—CH₂— | —CH₃ | H | 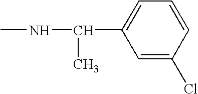 | —OH | 151° C. |
| 140 | —CH₂—CH₂— | —CH₃ | —CH₃ | 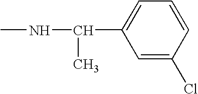 | —OH | 149° C. |
| 141 | —CH₂—CH₂— | H | H | 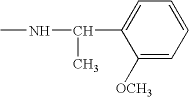 | —OH | 176° C. |
| 142 | —CH₂—CH₂— | —CH₃ | H | 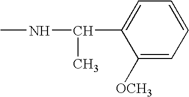 | —OH | 159° C. |
| 143 | —CH₂—CH₂— | —CH₃ | —CH₃ | 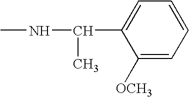 | —OH | 147° C. |
| 144 | —CH₂—CH₂— | —CH₃ | H | 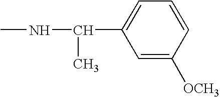 | —OH | 152° C. |
| 145 | —CH₂—CH₂— | —CH₃ | —CH₃ | 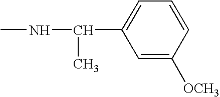 | —OH | 133° C. |
| 146 | —CH₂—CH₂— | H | H | 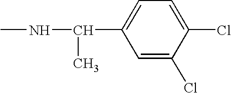 | —OH | 169° C. |
| 147 | —CH₂—CH₂— | —CH₃ | H | 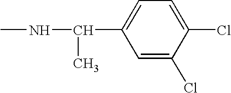 | —OH | 165° C. |
| 148 | —CH₂—CH₂— | —CH₃ | —CH₃ | 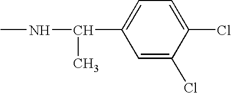 | —OH | 148° C. |
| 149 | —CH₂—CH₂— | —CH₃ | —CH₃ | 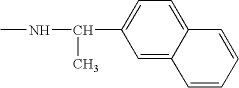 | —OH | 144° C. |
| 150 | —CH₂—CH₂— | —CH₃ | —CH₃ | 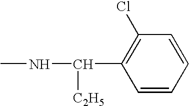 | —OH | 143° C. |
| 151 | —CH₂—CH₂— | —CH₃ | H | 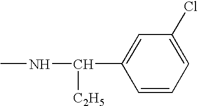 | —OH | 143° C. |
| 152 | —CH₂—CH₂— | —CH₃ | —CH₃ | 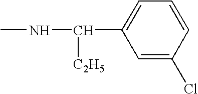 | —OH | 153° C. |
| 153 | —CH₂—CH₂— | H | H | 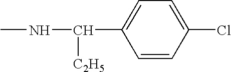 | —OH | 193° C. |
| 154 | —CH₂—CH₂— | —CH₃ | H | 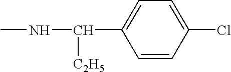 | —OH | 193° C. |
| 155 | —CH₂—CH₂— | —CH₃ | —CH₃ | 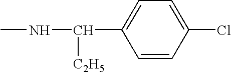 | —OH | 227° C. |
| 156 | —CH₂—CH₂— | H | H | 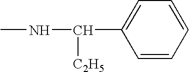 | —OH | 171° C. |
| 157 | —CH₂—CH₂— | —CH₃ | H | 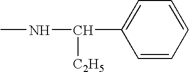 | —OH | 167° C. |
| 158 | —CH₂—CH₂— | —CH₃ | —CH₃ | 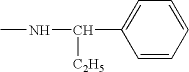 | —OH | 140° C. |
| 159 | —CH₂—CH₂— | H | H | 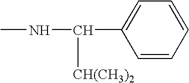 | —OH | 182° C. |
| 160 | —CH₂—CH₂— | —CH₃ | H | 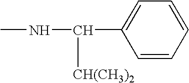 | —OH | 190° C. |
| 161 | —CH₂—CH₂— | —CH₃ | —CH₃ | 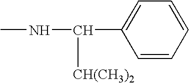 | —OH | 170° C. |
| 162 | —CH₂—CH₂— | H | H | 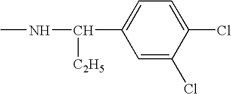 | —OH | 190° C. |
| 163 | —CH₂—CH₂— | —CH₃ | H | 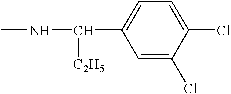 | —OH | 190° C. |
| 164 | —CH₂—CH₂— | —CH₃ | H | 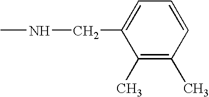 | —OH | 161° C. |
| 165 | —CH₂—CH₂— | —CH₃ | —CH₃ | 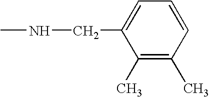 | —OH | 143° C. |
| 166 | —CH₂—CH₂— | H | H | 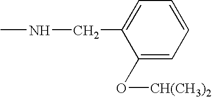 | —OH | 133° C. |
| 167 | —CH₂—CH₂— | —CH₃ | H | 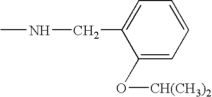 | —OH | 101° C. |
| 168 | —CH₂—CH₂— | —CH₃ | —CH₃ | 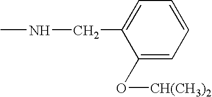 | —OH | 135° C. |
| 169 | —CH₂—CH₂— | —CH₃ | H | 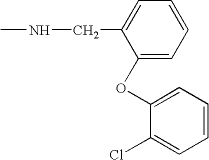 | —OH | 146° C. |
| 170 | —CH₂—CH₂— | H | H | 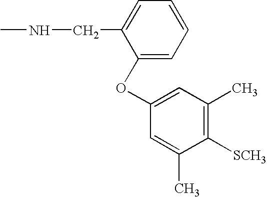 | —OH | 160° C. |
| 171 | —CH₂—CH₂— | —CH₃ | H | 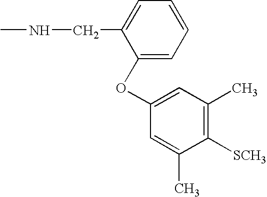 | —OH | 142° C. |
| 172 | —CH₂—CH₂— | H | H | 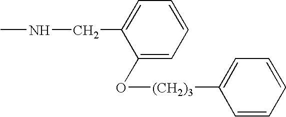 | —OH | 145° C. |
| 173 | —CH₂—CH₂— | —CH₃ | —CH₃ | 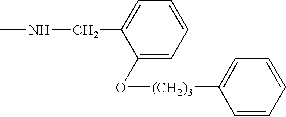 | —OH | 144° C. |
| 174 | —CH₂—CH₂— | H | H | 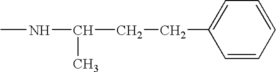 | —OH | 133° C. |
| 175 | —CH₂—CH₂— | —CH₃ | H | 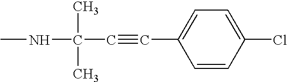 | —OH | 143° C. |
| 176 | —CH₂—CH₂— | —CH₃ | —CH₃ | 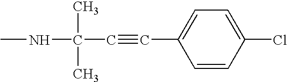 | —OH | 137° C. |
| 177 | —CH₂—CH₂— | H | H | 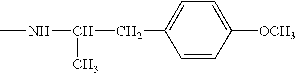 | —OH | 139° C. |
| 178 | —CH₂—CH₂— | H | H | 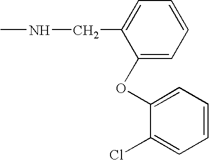 | —OH | |
| 179 | —CH₂—CH₂— | —CH₃ | —CH₃ | —OH | —OH | 126° C. |
| 180 | —CH₂—CH₂— | —CH₃ | —CH₃ | 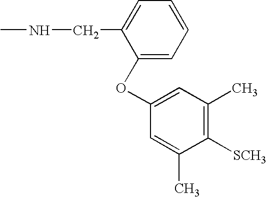 | —OH | 147° C. |
| 181 | —CH₂—CH₂— | H | H | 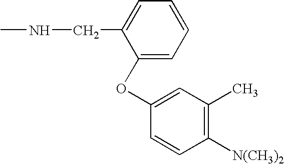 | —OH | 140° C. |
| 182 | —CH₂—CH₂— | —CH₃ | H | 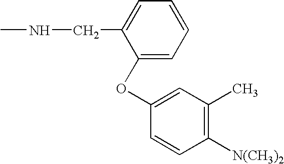 | —OH | 147° C. |
| 183 | —CH₂—CH₂— | —CH₃ | —CH₃ | 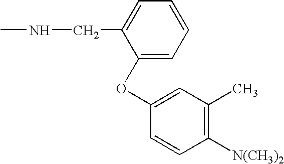 | —OH | 171° C. |
| 184 | —CH₂—CH₂— | H | H | 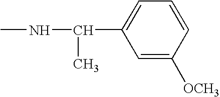 | —OH | 93° C. |
| 184 | —CH₂—CH₂— | H | H | 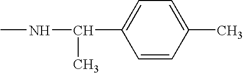 | —OH | 159° C. |
| 186 | —CH₂—CH₂— | —CH₃ | H | 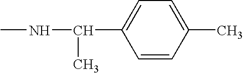 | —OH | 186° C. |
| 187 | —CH₂—CH₂— | —CH₃ | —CH₃ | 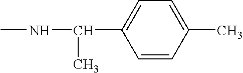 | —OH | 138° C. |
| 188 | —CH₂—CH₂— | H | H | 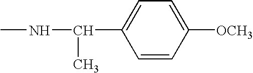 | —OH | 151° C. |
| 189 | —CH₂—CH₂— | —CH₃ | H | 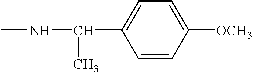 | —OH | 158° C. |
| 190 | —CH₂—CH₂— | H | H | 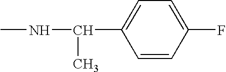 | —OH | 167° C. |
| 191 | —CH₂—CH₂— | —CH₃ | H | 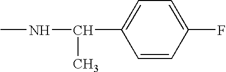 | —OH | 181° C. |
| 192 | —CH₂—CH₂— | —CH₃ | —CH₃ | 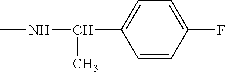 | —OH | 147° C. |
| 193 | —CH₂—CH₂— | H | H | 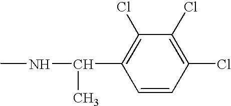 | —OH | 215° C. |
| 194 | —CH₂—CH₂— | —CH₃ | H | 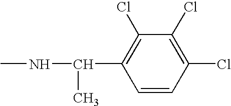 | —OH | 178° C. |
| 195 | —CH₂—CH₂— | —CH₃ | —CH₃ | 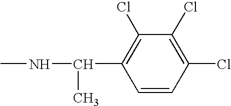 | —OH | 182° C. |
| 196 | —CH₂—CH₂— | H | H | 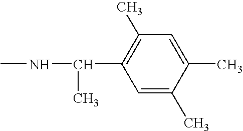 | —OH | 181° C. |
| 197 | —CH₂—CH₂— | H | H | 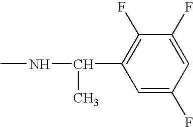 | —OH | 159° C. |
| 198 | —CH₂—CH₂— | —CH₃ | H | 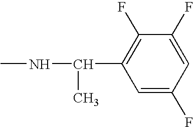 | —OH | 146° C. |
| 199 | —CH₂—CH₂— | —CH₃ | —CH₃ | 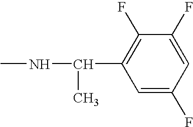 | —OH | 158° C. |
| 200 | —CH₂—CH₂— | H | H | 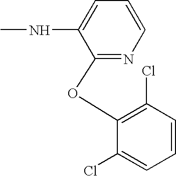 | —OH | 186° C. |
| 201 | —CH₂—CH₂— | CH₃ | H | 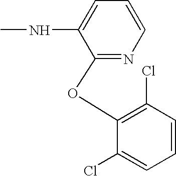 | —OH | 153° C. |
| 202 | —CH₂—CH₂— | H | H | 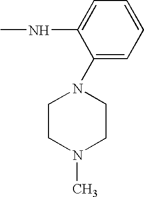 | —OH | 144° C. |
| 203 | —CH₂—CH₂— | —CH₃ | —CH₃ | 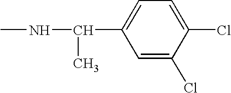 | —OH | 155° C. |
| 204 | —CH₂—CH₂— | H | H | 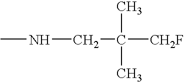 | —OH | 120° C. |
| 205 | —CH₂—CH₂— | —CH₃ | H | 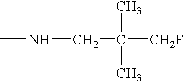 | —OH | 161° C. |
| 206 | —CH₂—CH₂— | —CH₃ | —CH₃ | 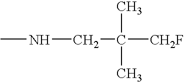 | —OH | 154° C. |
| 207 | —CH₂—CH₂— | H | H | 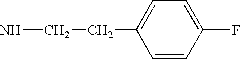 | —OH | 155° C. |
| 208 | —CH₂—CH₂— | —CH₃ | H | 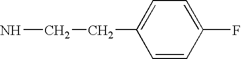 | —OH | 142° C. |
| 209 | —CH₂—CH₂— | —CH₃ | —CH₃ | 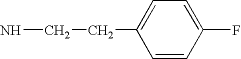 | —OH | 137° C. |
| 210 | —CH₂—CH₂— | H | H | 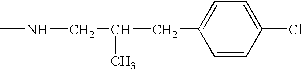 | —OH | 107° C. |
| 211 | —CH₂—CH₂— | —CH₃ | H | 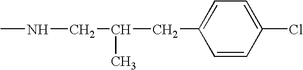 | —OH | 156° C. |
| 212 | —CH₂—CH₂— | —CH₃ | —CH₃ | 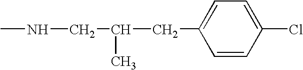 | —OH | 123° C. |
| 213 | —CH₂—CH₂— | —CH₃ | H | 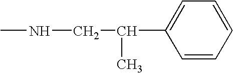 | —OH | 150° C. |
| 214 | —CH₂—CH₂— | —CH₃ | —CH₃ | 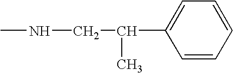 | —OH | 131° C. |
| 215 | —CH₂—CH₂— | H | H | 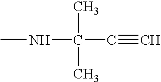 | —OH | 151° C. |
| 216 | —CH₂—CH₂— | —CH₃ | H | 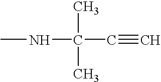 | —OH | 450° C. |
| 217 | —CH₂—CH₂— | —CH₃ | —CH₃ | 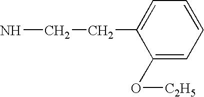 | —OH | 119° C. |
| 218 | —CH₂—CH₂— | —CH₃ | H | 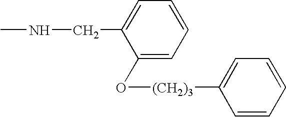 | —OH | 159° C. |
| 219 | —CH₂—CH₂— | —CH₃ | H | 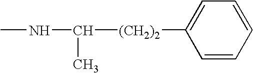 | —OH | 163° C. |
| 220 | —CH₂—CH₂— | H | H | 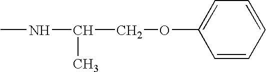 | —OH | 131° C. |
| 221 | —CH₂—CH₂— | —CH₃ | —CH₃ | 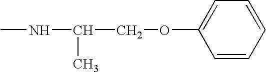 | —OH | 108° C. |
| 222 | —CH₂—CH₂— | —CH₃ | —CH₃ | 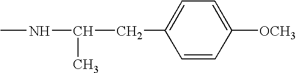 | —OH | 123° C. |
| 223 | —CH₂—CH₂— | —CH₃ | H | 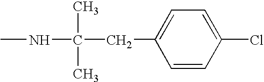 | —OH | 157° C. |
| 224 | —CH₂—CH₂— | H | H | 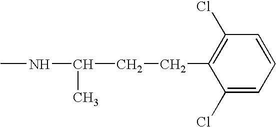 | —OH | 173° C. |
| 225 | —CH₂—CH₂— | —CH₃ | H | 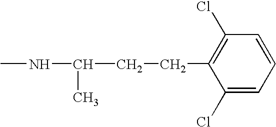 | —OH | 166° C. |
| 226 | —CH₂—CH₂— | —CH₃ | H | 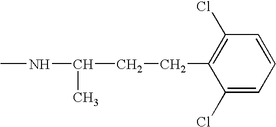 | —OH | 158° C. |
| 227 | —CH₂—CH₂— | —CH₃ | H | 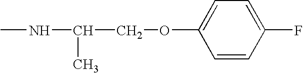 | —OH | 158° C. |
| 228 | —CH₂—CH₂— | —CH₃ | H | 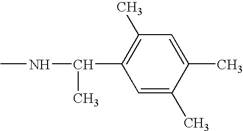 | —OH | 176° C. |
| 229 | —CH₂—CH₂— | —CH₃ | —CH₃ | 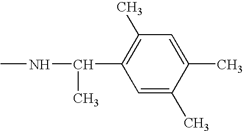 | —OH | 166° C. |
| 230 | —CH₂—CH₂— | H | H | 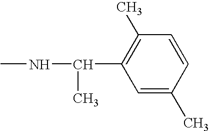 | —OH | 172° C. |
| 231 | —CH₂—CH₂— | —CH₃ | H | 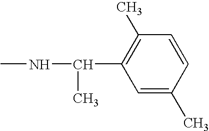 | —OH | 161° C. |
| 232 | —CH₂—CH₂— | —CH₃ | —CH₂ | 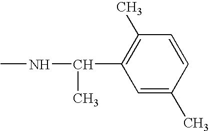 | —OH | 159° C. |
| 233 | —CH₂—CH₂— | H | H | 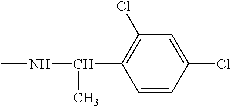 | —OH | 218° C. |
| 234 | —CH₂—CH₂— | —CH₃ | H | 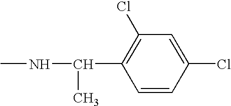 | —OH | 153° C. |
| 235 | —CH₂—CH₂— | —CH₃ | —CH₃ | 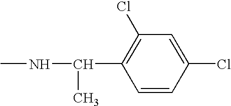 | —OH | 196° C. |
| 236 | —CH₂—CH₂— | H | H | 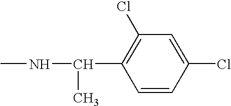 | —OH | 208° C. |
| 237 | —CH₂—CH₂— | —CH₃ | H | 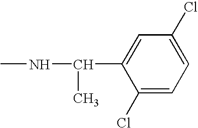 | —OH | 154° C. |
| 238 | —CH₂—CH₂— | —CH₃ | —CH₃ | 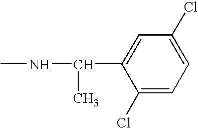 | —OH | 194° C. |
| 239 | —CH₂—CH₂— —CH₂—CH₂— | H H | H H | 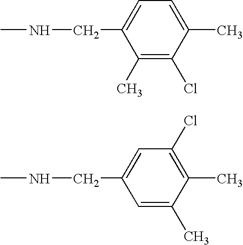 | 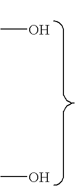 | |
| # 161° C. (Mixture of isomers) | | | | | | |
| 240 | —CH₂—CH₂— —CH₂—CH₂— | —CH₃ —CH₃ | H H | | | |
| # 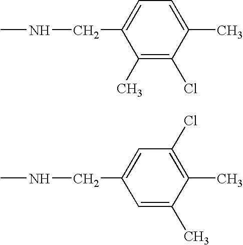 | 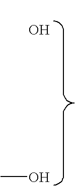 | 154° C. (Mixture of isomers) | | | | |
| 241 | —CH₂—CH₂— | H | H | 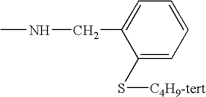 | —OH | 157° C. |
| 242 | —CH₂—CH₂— | —CH₃ | H | 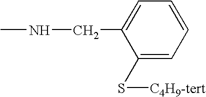 | —OH | 174° C. |
| 243 | —CH₂—CH₂— | —CH₃ | —CH₃ | 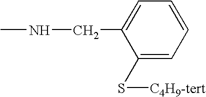 | —OH | 158° C. |
| 244 | —CH₂—CH₂— | H | H | 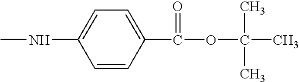 | —OH | 182° C. |
| 245 | —CH₂—CH₂— | —CH₃ | H | 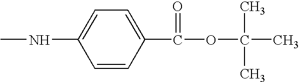 | —OH | 163° C. |
| 246 | —CH₂—CH₂— | —CH₃ | —CH₃ | 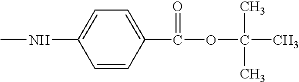 | —OH | 175° C. |
| 247 | —CH₂—CH₂— | H | H | 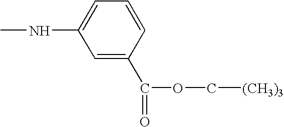 | —OH | 220° C. |
| 248 | —CH₂—CH₂— | —CH₃ | H | 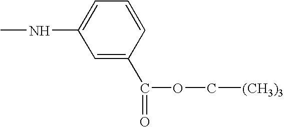 | —OH | 148° C. |
| 249 | —CH₂—CH₂— | —CH₃ | —CH₃ | 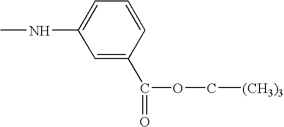 | —OH | 143° C. |
| 250 | —CH₂—CH₂— | H | H | 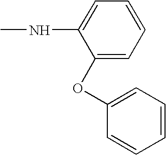 | —OH | 166° C. |
| 251 | —CH₂—CH₂— | —CH₃ | —CH₃ | 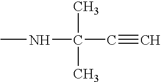 | 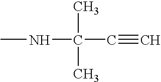 | 144° C. |
| 252 | —CH₂—CH₂— | H | H | 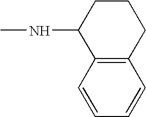 | —OH | 188° C. |
| 253 | —CH₂—CH₂— | —CH₃ | H | 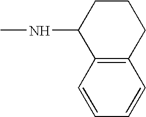 | —OH | 190° C. |
| 254 | —CH₂—CH₂— | —CH₃ | —CH₃ | 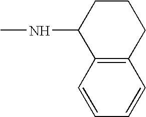 | —OH | 150° C. |
| 255 | —CH₂—CH₂— | H | H | 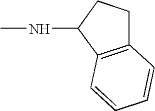 | —OH | 182° C. |
| 256 | —CH₂—CH₂— | —CH₃ | H | 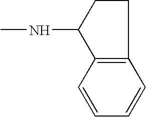 | —OH | 180° C. |
| 257 | —CH₂—CH₂— | —CH₃ | —CH₃ | 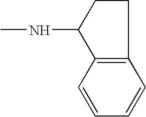 | —OH | 166° C. |
| 258 | —CH₂—CH₂— | H | H | —NH—(C(CH₃)₃ | —OH | 170° C. |
| 259 | —CH₂—CH₂— | —CH₃ | H | —NH—C(CH₃)₃ | —OH | 141° C. |
| 260 | —CH₂—CH₂— | —CH₃ | —CH₃ | —NH—C(CH₃)₃ | —OH | 145° C. |
| 261 | —CH₂—CH₂— | H | H | 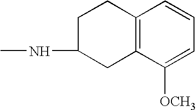 | —OH | 165° C. |
| 262 | —CH₂—CH₂— | —CH₃ | H | 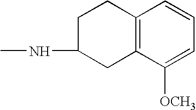 | —OH | 160° C. |
| 263 | —CH₂—CH₂— | H | H | 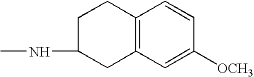 | —OH | 149° C. |
| 264 | —CH₂—CH₂— | —CH₃ | H | 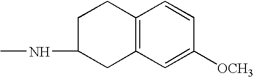 | —OH | 165° C. |
| 265 | —CH₂—CH₂— | —CH₃ | —CH₃ | 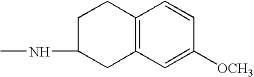 | —OH | 143° C. |
| 266 | —CH₂—CH₂— | —CH₃ | —CH₃ | 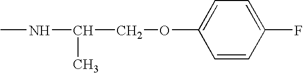 | —OH | 138° C. |
| 267 | —CH₂—CH₂— | H | H | 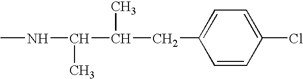 | —OH | 144° C. |
| 268 | —CH₂—CH₂— | —CH₃ | H | 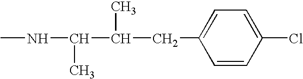 | —OH | 159° C. |
| 269 | —CH₂—CH₂— | —CH₃ | —CH₃ | 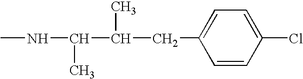 | —OH | 153° C. |
| 270 | —CH₂—CH₂— | —CH₃ | H | 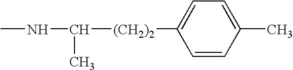 | —OH | 174° C. |
| 271 | —CH₂—CH₂— | H | H | 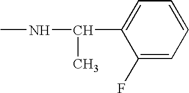 | —OH | 157° C. |
| 272 | —CH₂—CH₂— | —CH₃ | —CH₃ | 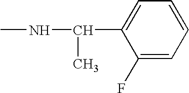 | —OH | 144° C. |

| | | | | |
|---|---|---|---|---|
| 273 | —CH₂—CH₂— | H | H | 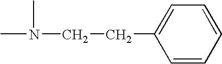 |

Preparation of the Compound According to Example No. 70

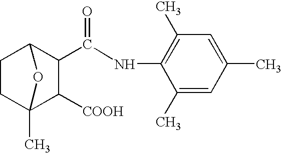

2.7 g (20 mmol) of 2,4,6-trimethylaniline were added to a solution of 3.6 g (20mmol) of 1-methyl-7-oxabicyclo[2.2.1]heptane-2,3-dicarboxylic acid anhydride in 20 ml of acetoritrile at room temperature. The mixture was stirred at a temperature of 35° C. for 4 hours. The colourless precipitate formed was filtered off, washed with acetonitrile and then with diethylether and dried. 5.2 g (=82% of theory) of the compound of the formula shown above were obtained in this manner in the form of a solid having a melting point of 168° C.

### USE EXAMPLES

### Example A

Erysiphe Test (Barley)/Induction of Resistance

| | |
|---|---|
| Solvent: | 50 parts by weight of N,N-dimethylformamide |
| Emulsifier: | 1.17 parts by weight of alkylaryl polyglycol ether |

To produce a suitable preparation of active compound, 1 part by weight of active compound is mixed with the stated amount of solvent, and the concentrate is diluted with water and the stated amount of emulsifier to the desired concentration.

To test for resistance-inducing activity, young barley plants are sprayed with the preparation of active compound at the stated rate of application. 4 days after the treatment, the plants are inoculated with an aqueous spore suspension of Erysiphe graminis f. sp.hordei. The plants are subsequently placed in a greenhouse at 70% relative atmospheric humidity and 18° C.

The test is evaluated 7 days after the inoculation. 0% means an efficacy which corresponds to that of the control while an efficacy of 100% means that no disease is observed.

The active compounds, active compound concentrations and results can be seen from the following table:

TABLE A
Erysiphe test (barley)/induction of resistance

| | Rate of | |
|---|---|---|
| | application | |
| | of active | |
| | compound | Efficacy |
| Active compound | in g/ha | in % |
| According to the invention: | | |
| 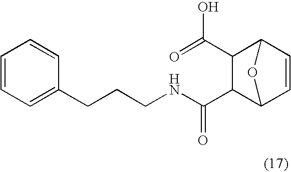 | 750 | 70 |
| 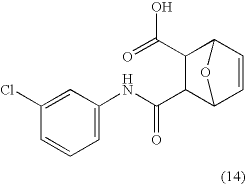 | 750 | 70 |
| 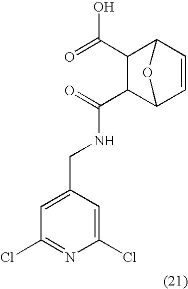 | 750 | 70 |
| 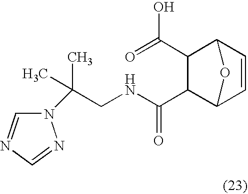 | 750 | 70 |
| 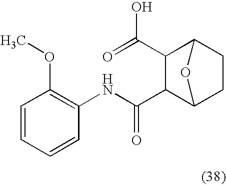 | 750 | 70 |
| 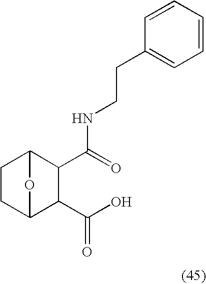 | 750 | 90 |
| 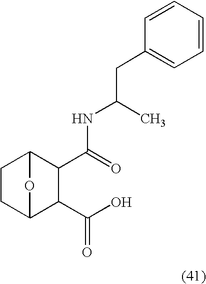 | 750 | 80 |

### Example B

Tetranychus Test (OP Resistant/Dip Treatment)

| | |
|---|---|
| Solvent: | 7 parts by weight of dimethylformamide |
| Emulsifier: | 1 part by weight of alkylaryl polyglycol ether |

To produce a suitable preparation of active compound, 1 part by weight of active compound is mixed with the stated amount of solvent and the stated amount of emulsifier, and the concentrate is diluted with emulsifier-containing water to the desired concentration.

Bean plants (Phaseolus vulgaris) which are heavily infested by all stages of the greenhouse red spider mite (Tetranychus urticae) are dipped into a solution of the active compound at the desired concentration.

After the desired period of time, the effect in % in determined. 100% means that all spider mites have been killed; 0% means that none of the spider mites have been killed.

Active compounds, concentrations of active compound and test results are shown in the table below.

TABLE B
(plant-damaging insects)
Tetranychus test (OP-resistant/dip treatment)

| | Concentration of active | Kill in % after 7 |
|---|---|---|
| Active compound | compound in ppm | days |
| According to the invention: | | |
| 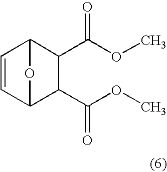 | 1000 | 90 |

### Example C

Nephotettix Test

| | |
|---|---|
| Solvent: | 7 parts by weight of dimethylformamide |
| Emulsifier: | 1 part by weight of alkylaryl polyglycol ether |

To produce a suitable preparation of active compound, 1 part by weight of active compound is mixed with the stated amount of solvent and the stated amount of emulsifier, and the concentrate is diluted with water to the desired concentration.

Rice seedlings (Oryza sativa) are treated by being dipped into the preparation of active compound of the desired concentration and are infested with larvae of the green rice leaf hopper (Nephotettix cincticeps) while the seedlings are still moist.

After the desired period of time, the kill in % is detemruned. 100% means that all leaf hoppers have been killed; 0% means that none of the leaf hoppers have been killed.

Active compounds, concentrations of active compound and test results are shown in the table below.

TABLE C
(plant-damaging insects)
Nephotettix test

| | Concentration of active | Kill in % after 6 |
|---|---|---|
| Active compound | compound in ppm | days |
| According to the invention: | | |
| 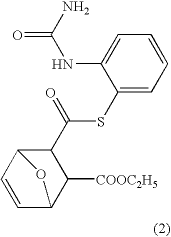 | 1000 | 100 |
| 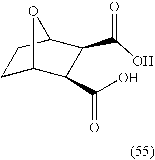 | 1000 | 100 |

### Example D

Myzus Test

| | |
|---|---|
| Solvent: | 7 parts by weight of dimethylformamide |
| Emulsifier: | 1 part by weight of alkylaryl polyglycol ether |

To produce a suitable preparation of active compound, 1 part by weight of active compound is mixed with the stated amounts of solvent and of emulsifier, and the concentrate is diluted with emulsifier—containing water to the desired concentration.

Cabbage leaves (Brassica oleracea) which are heavily infested by Myzus persicae are dipped into a preparation of active compound of the desired concentration.

After the desired period of time, the kill in % is determined. 100% means that all aphids have been killed; (0)% means that none of the aphids nave been killed.

Active compounds, concentrations of active compound and test results are shown in the table below.

TABLE D
(plant-damaging insects)
Myzus test

| | Concentration of active | kill in % after |
|---|---|---|
| Active compound | compound in ppm | 6 days |
| According to the invention: | | |
| 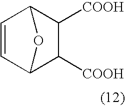 | 100 | 80 |

### Example E

Phaedon Larvae Test

| | |
|---|---|
| Solvent: | 7 parts by weight of dimethylformamide |
| Emulsifier: | 1 part by weight of alkylaryl polyglycol ether |

To produce a suitable preparation of active compound, 1 part by weight of active compound is mixed with the stated amounts of solvent and of emulsifier, and the concentrate is diluted with emulsifier—containing water to the desired concentration.

Cabbage leaves (Brassica oleracea) are treated by being dipped into the preparation of active compound of the desired concentration and are infested with larvae of Phaedon cochleariae while the leaves are still moist.

After the desired period of time, the kill in % is determined. 100% means that all beetle larvae have been killed; 0% means that no beetle larvae have been killed.

Active compounds, concentrations of active compound and test results are shown in the table below.

TABLE E
(plant damaging insects)
Phaedon larvae test

| | Concentration of active | kill in % after |
|---|---|---|
| Active compound | compound in ppm | 7 days |
| According to the invention: | | |
| 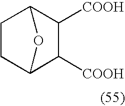 | 1000 | 100 |

### Example F

Meloidoyne Test

| | |
|---|---|
| Solvent: | 8 parts by weight of acetone |
| Emulsifier: | 1 part by weight of alkylaryl polyglycol ether |

To produce a suitable preparation of active compound, 1 part by weight of active compound is mixed with the stated amounts of solvent and of emulsifier, and the concentrate is diluted with water to the desired concentration.

Containers are filled with sand, preparation of active compound, a suspension of egg-larvae of Meloidogyne incognita and with lettuce seeds. The lettuce seeds germinate and the plants are allowed to grow. Galls are formed on the roots.

After the desird period of time, the nematocidal activity is determined on basis of the formation of galls and is calculated in %.

An activity of 100% means that no galls have been found, an activity of 0% means that the number of the galls at the treated plants corresponds to the number of galls in the untreated control plants.

Active compounds, concentrations of active compound and test results are shown in the table below.

TABLE E
(nematocides)
Meloidogyne incognita test

| | Concentration of active | |
|---|---|---|
| Active compound | compound in ppm | kill in % |
| According to the invention: | | |
| 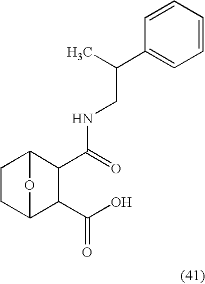 | 20 | 100 |

1. Use of 7-oxabicyclo[2.2.1]heptane derivatives of the formula 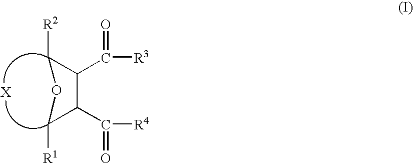
in which
X represents a group of the formula —CH₂—CH₂— or —CH═CH—,
R¹ and R², independently of one another, represent hydrogen or methyl,
R³ represents a group selected from —OR⁵, —SR⁶ and —NH—R⁷,
wherein
R⁵, R⁶ and R⁷, independently of one another, represent hydrogen, alkyl, halogenoalkyl, alkoxyalkyl, halogenoalkoxy-alkyl, alkinyl, optionally substituted cycloalcyl, optionally substituted aryl, optionally substituted aralkyl, optionally substituted aryloxyalkyl, optionally substituted arylalkinyl, optionally substituted heterocyclyl or optionally substituted heterocyclyl alkyl, and
R⁴ represents a group selected from —OR⁸, —SR⁹ and —NH—R¹⁰, wherein
R⁸, R⁹ and R¹⁰, independently of one another, represent hydrogen, alkyl, halogenoalkyl, alkoxyalkyl, halogenoalkoxy-alkyl, alkinyl, optionally substituted cycloalkyl, optionally substituted aryl, optionally substituted aralkyl, optionally substituted aryloxyalkyl, optionally substituted arylalkinyl, optionally substituted heterocyclyl or optionally substituted heterocyclylalkyl, or
R³ and R⁴ together represent a group of the formula 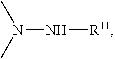
wherein
R¹¹ represents optionally substituted aryl, or
R³ and R⁴ together represent a group of the formula 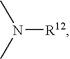
wherein
R¹² represents optionally substituted aralkyl, for controlling undesired microorganisms and animal pests.

2. Method for controlling undesired microorganisms and animal pests, characterized in that 7-oxabicyclo[2.2.1]heptane derivatives of the formula (I), according to claim 1 are applied to the microorganisms or animal pests or to their habitat.

3. 7-oxabicyclo[2.2.1]heptane derivatives of the formula 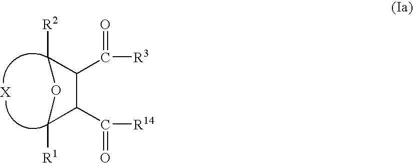
in which
X represents a group of the formula —CH₂—CH₂— or —CH═CH—,
R¹ and R², independently of one another, represent hydrogen or methyl,
R³ represents a group selected from —OR⁵, —SR⁶ and —NH—R⁷,
wherein
R⁵, R⁶ and R⁷, independently of one another, represent hydrogen, alkyl, halogenoalkyl, alkoxyalkyl, halogenoalkoxyalkyl, alkinyl, optionally substituted cycloalkyl, optionally substituted aryl, optionally substituted aralkyl, optionally substituted aryloxyalkyl, optionally substituted arylalkinyl, optionally substituted heterocyclyl or optionally substituted heterocyclylalkyl, and
R¹⁴ represents a group selected from —SR⁹ and —NH—R¹⁰, wherein
R⁹ represents hydrogen straight-chain or branched alkyl having 1 to 8 carbon atoms, halogenoalkyl having 1 to 8 carbon atoms and 1 to 6 halogen atoms, alkoxyalkyl having 1 to 6 carbon atoms in the alkyl group and 1 to 6 carbon atoms in each alkoxy group, halogenoalkoxyalkyl having 1 to 6 carbon atoms in the alkyl group and 1 to 6 carbon atoms as well as 1 to 6 halogen atoms in each halogenoalkoxy group, alkinyl having 3 to 8 carbon atoms, or
R⁹ represents cycloalkyl having 3 to 7 carbon atoms, wherein each of these groups may be mono- to tri-substituted by identical or different radicals selected from alkyl having 1 to 4 carbon atoms and alkoxy having 1 to 4 carbon atoms, or wherein the cycloalkyl group may contain a fused phenyl ring, which in turn may be substituted by one to three identical or different radicals selected from alkyl having 1 to 4 carbon atoms and alkoxy having 1 to 4 carbon atoms, or
R⁹ represents aryl having 6 to 10 carbon atoms, wherein each of these groups may be mono- to tri-substituted by identical or different radicals selected from the group consisting of halogen, nitro, cyano, aminocarbonylamino, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenoxy, halophenoxy, carbalkoxy having 1 to 6 carbon atoms in the alkoxy group, and piperazinyl, which in turn may be substituted by alkyl having 1 to 4 carbon atoms, or
R⁹ represents arylalkyl having 6 to 10 carbon atoms in the aryl group and 1 to 6 carbon atoms in the alkyl group, wherein each of these groups may be mono- to tri-substituted by identical of different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenylalkoxy having 1 to 4 carbon atoms in the alkoxy group, alkylthio having 1 to 6 carbon atoms and phenoxy, which in turn may be substituted by halogen, alkyl having 1 to 4 carbon atoms, alkylthio having 1 to 4 carbon atoms and/or dialkylamino having 1 to 4 carbon atoms in each alkyl group, or
R⁹ represents aryloxyalkyl having 6 to 10 carbon atoms in the aryloxy group and 1 to 4 carbon atoms in the alkyl group, wherein the aryloxy group may be substituted by 1 to 3 identical or different radicals selected from halogen and alkyl having 1 to 4 carbon atoms, or
R⁹ represents arylalkinyl having 6 to 10 carbon atoms in the aryl group and 3 to 6 carbon atoms in the alkinyl group, wherein the aryl group may be substituted by 1 to 3 identical or different radicals selected from halogen and alkyl having 1 to 4 carbon atoms, or
R⁹ represents 5- or 6-membered heterocyclyl having 1 to 3 heteroatoms, such as nitrogen, sulphur and/or oxygen, wherein the heterocyclic groups may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy, which in turn may be substituted by 1 to 3 halogen atoms, or
R⁹ represents 5- or 6-membered heterocyclylalkyl having 1 to 6 carbon atoms in the alkyl group and 1 to 3 heteroatoms, such as nitrogen, sulphur and/or oxygen, in the heterocyclyl group, wherein the heterocyclyl groups may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy, and
R¹⁰ represents hydrogen, straight-chain or branched alkyl having 1 to 8 carbon atoms, halogenoalkyl having 1 to 8 carbon atoms and 1 to 6 halogen atoms, alkoxyalkyl having 1 to 6 carbon atoms in the alkyl group and 1 to 6 carbon atoms in each alkoxy group, halogenoalkoxyalkyl having 1 to 6 carbon atoms in the alkyl group and 1 to 6 carbon atoms as well as 1 to 6 halogen atoms in each halogenoalkoxy group, alkiyl having 3 to 8 carbon atoms, or
R¹⁰ represents cycloalkyl having 3 to 7 carbon atoms, wherein each of these groups may be mono- to tri-substituted by identical or different radicals selected from alkyl having 1 to 4 carbon atoms and alkoxy having 1 to 4 carbon atoms, or wherein the cycloalkyl group may contain a fused phenyl ring, which in turn may be substituted by one to three identical or different radicals selected from alkyl having 1 to 4 carbon atoms and alkyoxy having 1 to 4 carbon atoms, or
R¹⁰ represents aryl having 6 to 10 carbon atoms, wherein each of these groups may be mono- to tri-substituted by identical or different radicals selected from the group consisting of halogen, nitro, cyano, aminocarbonylamino, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl, phenoxy, halophenoxy, carbalkoxy having 1 to 6 carbon atoms in the alkoxy group, and piperazinyl, which in turn may be substituted by alkyl having 1 to 4 carbon atoms, or
R¹⁰ represents arylalkyl having 6 to 10 carbon atoms in the aryl group and 1 to 6 carbon atoms in the alkyl group, wherein each of these groups may be mono- to tri-substituted by identical of different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical of different halogen atoms, cycloalkyl having 3 to 8 carbon atoms, phenyl, phenylalkoxy having 1 to 4 carbon atoms in the alkoxy group, alkylthio having 1 to 6 carbon atoms and phenoxy, which in turn may be substituted by halogen, alkyl having 1 to 4 carbon atoms, alkylthio having 1 to 4 carbon atoms and/or dialkylamino having 1 to 4 carbon atoms in each alkyl group, or
R¹⁰ represents aryloxyalkyl having 6 to 10 carbon atoms in the aryloxy group and 1 to 4 carbon atoms in the alkyl group, wherein the aryloxy group may be substituted by 1 to 3 identical or different radicals selected from halogen and alkyl having 1 to 4 carbon atoms, or
R¹⁰ represents arylalkinyl having 6 to 10 carbon atoms in the aryl group and 3 to 6 carbon atoms in the alkinyl group, wherein the aryl group may be substituted by 1 to 3 identical or different radicals selected from halogen and alkyl having 1 to 4 carbon atoms, or
R¹⁰ represents 5 or 6-membered heterocyclyl having 1 to 3 heteroatoms, such as nitrogen, sulphur and/or oxygen, wherein the heterocyclic groups may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy, which in turn may be substituted by 1 to 3 halogen atoms, or
R¹⁰ represents 5- or 6-membered heterocyclylalkyl having 1 to 6 carbon atoms in the alkyl group and 1 to 3 heteroatoms, such as nitrogen, sulphur and/or oxygen, in the heterocyclyl group wherein the heterocyclyl groups may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy, or
R³ and R¹⁴ also together represent a group of the formula 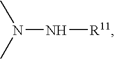
wherein
R¹¹ represents aryl having 6 to 10 carbon atoms, wherein each of these groups may be mono- to tri-substituted by identical or different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy, or
R³ and R¹⁴ represent a group of the formula 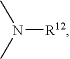
wherein
R¹² represents aralkyl having 6 to 10 carbon atoms in the aryl group and 1 to 4 carbon atoms in the alkyl group, wherein the aryl group may be substituted by 1 to 3 identical of different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy.

4. Process for the preparation of 7-oxabicyclo[2.2.1]heptane derivatives of the formula (Ia) according to claim 3, characterized in that
a) acid anhydrides of the formula 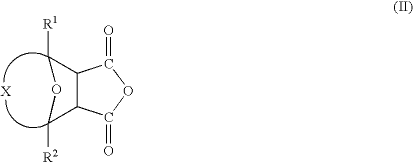
in which
X, R¹ and R² have the above-mentioned meanings, are reacted with
α) compounds of the formula
HO—R⁵ (III)
in which
R⁵ has the above-mentioned meanings,
if appropriate in the presence of a diluent and if appropriate in the presence of a catalyst, or
β) with compounds of the formula
HS—R⁶ (IV)
in which
R⁶ has the above-mentioned meanings,
if appropriate in the presence of a diluent and if appropriate in the presence of a catalyst, or
γ) with compounds of the formula
H₂N—R⁷ (V)
in which
R⁷ has the above-mentioned meanings,
if appropriate in the presence of a diluent, or
δ) with compounds of the formula
H₂N—NH—R¹¹ (VI)
in which
R¹¹ has the above-mentioned meanings,
if appropriate in the presence of a diluent, or
ε) with compounds of the formula
H₂N—R¹² (VII)
in which
R¹² has the above-mentioned meanings,
if appropriate in the presence of a diluent, or
b) reacting 7-oxabicyclo[2.2.1]heptane derivatives of the formula 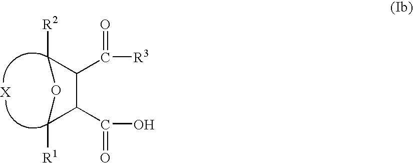
in which
X, R¹, R² and R³ have the above-mentioned meanings,
in a first step with ethyl chloroformate of the formula 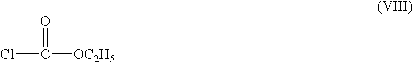
in the presence of a diluent and in the presence of an acid binder,
and reacting in a second step the resulting compounds of the formula 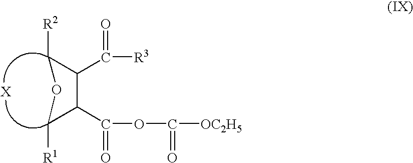
in which
X, R¹, R² and R³ have the above-mentioned meanings,
with compounds of the formula
H—R¹⁴ (X)
in which
R¹⁴ has the above-mentioned meanings,
in the presence of a diluent and if appropriate in the presence of an acid binder.

5. Microbicidal and pesticidal compositions, characterized by comprising at least one 7-oxabicyclo[2.2.1]heptane derivative of the formula (Ia) according to claim 3 in admixture with extenders and/or surface-active agents.

6. Process for the preparation of microbicidal and pesticidal compositions, characterized in that 7-oxabicyclo[2.2.1]heptane derivatives of the formula (Ia) according to claim 3 are mixed with extenders and/or surface-active agents.
